(19) United States
(12) Patent Application Publication
(10) Pub. No.: US 2026/0077600 A1
(43) Pub. Date: Mar. 19, 2026

(54) LIQUID EJECTION HEAD AND LIQUID EJECTION APPARATUS

(71) Applicant: CANON KABUSHIKI KAISHA, Tokyo (JP)

(72) Inventors: YOSHIYUKI NAKAGAWA, Kanagawa (JP); TAKASHI KATO, Kanagawa (JP)

(21) Appl. No.: 19/327,543

(22) Filed: Sep. 12, 2025

(30) Foreign Application Priority Data
Sep. 17, 2024 (JP) 2024-160051

(51) Int. Cl. B41J 2/20; B41J 2/14; B41J 2/18

(52) U.S. Cl. CPC B41J 2/20; B41J 2/14072; B41J 2/18

(57) ABSTRACT

A liquid ejection head in which a plurality of ejection nozzles is arranged in a first direction includes: a first flow passage communicating with one end of each of a plurality of individual flow passages; a second flow passage communicating with the other end of each of the plurality of individual flow passages; a plurality of first openings provided in the first flow passage; and a plurality of second openings provided in the second flow passage, in which D2>D1, in which D1 represents a size of a non-open part in a first direction between the two adjacent first openings, and D2 represents a size of a non-open part in the first direction between the two adjacent second openings.

### BACKGROUND

### Field of the Technology

The present disclosure relates to a liquid ejection head and a liquid ejection apparatus.

### Description of the Related Art

In a circulation type liquid ejection apparatus, ink circulates in order to discharge a bubble in a flow passage in a liquid ejection head and suppress thickening of the ink near an ejection nozzle. As a method of circulating the ink, there is a differential pressure method using a pressure difference. In the differential pressure method, a pressure adjustment mechanism or the like is used to make a pressure on a flow-in side for supplying the ink to an ejection nozzle higher than a pressure on a flow-out side for collecting the ink, so that the ink flows from the flow-in side toward the flow-out side. At this time, to circulate the ink, it is necessary to return the ink that has flowed to the flow-out side to the flow-in side, and a pump is required as a mechanism for that purpose. Note that the pump may be provided at a position outside a head, such as a main body of a recording apparatus, to circulate the liquid between the liquid ejection head and the main body. Alternatively, the pump may be provided inside the liquid ejection head to circulate the liquid in the liquid ejection head. However, such a differential pressure circulation method requires mechanisms such as the pressure adjustment mechanism and the pump, and therefore, the main body of the recording apparatus and the head may increase in size.

Therefore, ink circulation methods other than the differential pressure method have been studied. Specifically, in addition to a first energy generation element that generates energy for ejecting the ink, a second energy generation element that generates energy for causing a liquid to flow is disposed in an individual flow passage communicating with an ejection nozzle. Further, a mechanism for circulating the ink by causing the ink to flow in the individual flow passage by driving the second energy generation element is known. Japanese Patent Application Laid-open No. 2020-104312 discusses a configuration in which a flow passage extending in a direction intersecting an ejection nozzle array in which a plurality of ejection nozzles is arranged is provided, and the first energy generation element and the second energy generation element are provided in the flow passage.

Here, a chip configuration of a liquid ejection head discussed in Japanese Patent Application Laid-open No. 2020-104312, which includes an element that generates ejection energy and an element that generates flow energy, has room for improvement in ejection characteristic and circulation characteristic for ink as a recording liquid.

### SUMMARY

The present disclosure addresses shortcomings of conventional systems and provides a technology capable of improving an ejection characteristic and a circulation characteristic for a liquid in a liquid ejection head including an energy generation element for ejecting the liquid and an energy generation element for causing the liquid to flow.

An aspect of the present disclosure provides a liquid ejection head that includes an ejection nozzle array that includes a plurality of ejection nozzles arranged in a first direction; a plurality of individual flow passages configured to communicate with respective ejection nozzles of the plurality of ejection nozzles of the ejection nozzle array, extending in a second direction intersecting the first direction; a first energy generation element configured to generate energy for ejecting liquid from at least one ejection nozzle, with the first energy generation element being provided in at least one flow passage of the plurality of individual flow passages at a position corresponding to at least one ejection nozzle; a second energy generation element configured to generate energy for causing the liquid to flow, with the second energy generation element being provided in at least one flow passage of the plurality of individual flow passages at a position different from the first energy generation element in the second direction; a first flow passage in communication with one end of each of the plurality of individual flow passages; a second flow passage in communication with an other end of each of the plurality of individual flow passages; a plurality of first openings that are provided in the first flow passage, are arranged in the first direction, and allow the liquid to flow into or flow out from the first flow passage; and a plurality of second openings that are provided in the second flow passage, arranged in the first direction and configured to allow the liquid to flow at least one of into or out from the second flow passage, with D2>D1, with D1 representing a size of a non-open part in the first direction between two adjacent first openings of the plurality of first openings, and D2 representing a size of a non-open part in the first direction between the adjacent second openings of the plurality of second openings.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view illustrating a configuration of a liquid ejection apparatus in a case where a main ink tank is provided outside a liquid ejection head according to a first embodiment;

FIG. 1B is a perspective view illustrating a configuration of the liquid ejection apparatus in a case where an ink tank is included in the liquid ejection head;

FIG. 2A is an exploded perspective view illustrating the liquid ejection head according to the first embodiment;

FIG. 2B is a view illustrating a configuration in which ejection nozzle arrays for inks of four colors are provided in one liquid ejection chip, and the inks of four colors can be ejected by one liquid ejection chip;

FIG. 2C is a view illustrating a configuration in which ejection nozzles for inks of two colors are provided in one liquid ejection chip and inks of four colors can be ejected by two liquid ejection chips;

FIG. 2D is a view illustrating a configuration in which an ejection nozzle for ink of one color is provided in one liquid ejection chip and inks of four colors can be ejected by four liquid ejection chips;

FIG. 3A is a view illustrating a configuration in the vicinity of the ejection nozzle of the liquid ejection head in a straight ink circulation configuration according to the first embodiment, viewed in a Z direction;

FIG. 3B is a cross-sectional view taken along line A-A in FIG. 3A;

FIG. 3C is a cross-sectional view of the liquid ejection head having a configuration different from that of FIG. 3B, taken along line A-A;

FIG. 3D is a cross-sectional view taken along line A-A in FIG. 3A, illustrating a flow of the ink ejected from the ejection nozzle;

FIG. 4A is a view illustrating a state in which a bubble is generated when a second energy generation element is driven in the straight ink circulation configuration according to the first embodiment;

FIG. 4B is a view illustrating a flow of the ink in a process in which the bubble contracts in the straight ink circulation configuration according to the first embodiment;

FIG. 4C is a view illustrating a flow of the ink after the bubble collapses in the straight ink circulation configuration according to the first embodiment;

FIG. 5A is a view illustrating a state in a case where a recording operation of the liquid ejection apparatus is temporarily paused in the straight ink circulation configuration according to the first embodiment;

FIG. 5B is a view illustrating a state immediately after a circulation flow is generated by the second energy generation element after the state in FIG. 5A in the straight ink circulation configuration according to the first embodiment;

FIG. 5C is a view illustrating a state in a case where the recording operation is temporarily paused again after FIG. 5B in the straight ink circulation configuration according to the first embodiment;

FIG. 5D is a view illustrating a state immediately after a circulation flow is generated by the second energy generation element again after FIG. 5C in the straight ink circulation configuration according to the first embodiment;

FIG. 6A is a view illustrating a state in a case where a recording operation of a liquid ejection apparatus is temporarily paused in a U-shaped ink circulation configuration according to a comparative example;

FIG. 6B is a view illustrating a state immediately after a circulation flow is generated by a second energy generation element after FIG. 6A in the U-shaped ink circulation configuration according to the comparative example;

FIG. 6C is a view illustrating a state in a case where the recording operation is temporarily paused again after FIG. 6B in the U-shaped ink circulation configuration according to the comparative example;

FIG. 6D is a view illustrating a state immediately after a circulation flow is generated again by the second energy generation element after FIG. 6C in the U-shaped ink circulation configuration according to the comparative example;

FIG. 7A is a view illustrating a configuration in the vicinity of an ejection nozzle of a liquid ejection head in the U-shaped ink circulation configuration according to the comparative example, and is a view illustrating main components when the liquid ejection head is viewed in a Z direction;

FIG. 7B is a cross-sectional view taken along line A-A in FIG. 7A in the U-shaped ink circulation configuration according to the comparative example;

FIG. 7C is a view illustrating the vicinity of an individual flow passage in FIG. 7A in the U-shaped ink circulation configuration according to the comparative example;

FIG. 8 is a diagram illustrating a control configuration of the liquid ejection apparatus according to the first embodiment;

FIG. 9A is a view illustrating a configuration in the vicinity of an ejection nozzle of a liquid ejection head according to the first embodiment, viewed in the Z direction;

FIG. 9B is a cross-sectional view taken along line A-A in FIG. 9A;

FIG. 9C is a cross-sectional view taken along line A-A in FIG. 9A of the liquid ejection head having a configuration different from that of FIG. 9B;

FIG. 10A is a view illustrating a configuration in the vicinity of an ejection nozzle of a liquid ejection head according to a second embodiment, viewed in a Z direction;

FIG. 10B is a cross-sectional view taken along line A-A in FIG. 10A;

FIG. 10C is a cross-sectional view taken along line A-A in FIG. 10A of the liquid ejection head having a configuration different from that of FIG. 10B;

FIG. 11 is a view illustrating the liquid ejection head according to the second embodiment;

FIG. 12A is a view illustrating a configuration in the vicinity of an ejection nozzle of a liquid ejection head according to a third embodiment, viewed in a Z direction;

FIG. 12B is a cross-sectional view taken along line A-A in FIG. 12A;

FIG. 13A is a view illustrating a configuration in the vicinity of an ejection nozzle of a liquid ejection head according to a modified example of the third embodiment;

FIG. 13B is a view illustrating a configuration in the vicinity of an ejection nozzle of a liquid ejection head according to still another modified example of the third embodiment; and

FIG. 14 is a block diagram illustrating a control configuration of the liquid ejection apparatus according to the first embodiment.

### DESCRIPTION OF THE EMBODIMENTS

In the following, embodiments of the present disclosure will be described in detail with reference to the accompanying drawings. Note that the following embodiments do not limit the subject matter of the present disclosure, and not all of the combinations of features described in the embodiments are necessarily essential to the solution according to the present disclosure. The same components are denoted by the same reference numerals. In the description below, a basic configuration according to the present disclosure is first explained, followed by explanation of characteristic components according to the present disclosure.

### First Embodiment

A liquid ejection apparatus 50 according to a first embodiment of the present disclosure will be described. The liquid ejection apparatus 50 is an inkjet recording apparatus that uses an inkjet recording method, and includes a liquid ejection head 1 capable of ejecting ink as a liquid.

### <Liquid Ejection Apparatus>

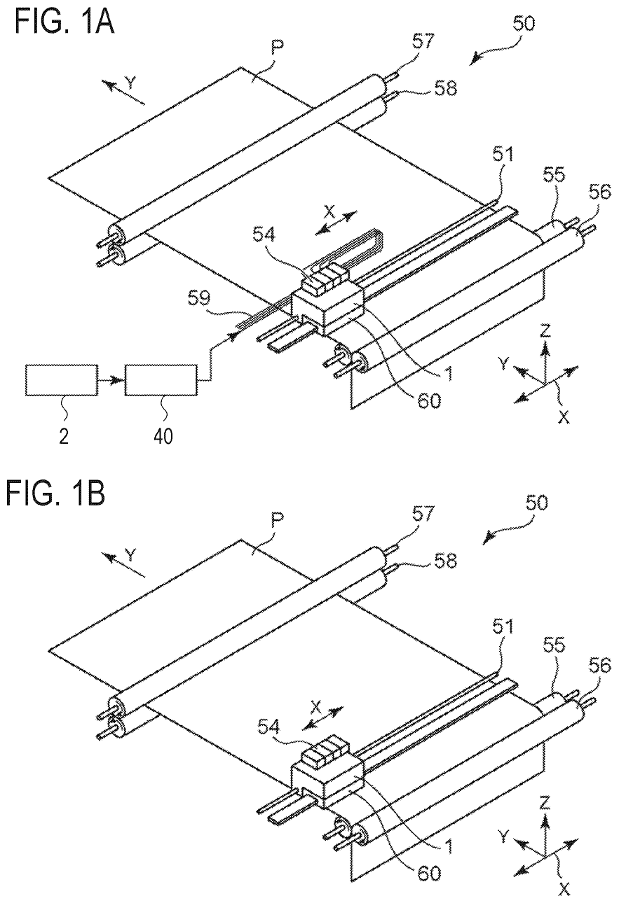

FIGS. 1A and 1B are perspective views illustrating a configuration of the liquid ejection apparatus 50 according to the first embodiment. The liquid ejection apparatus 50 illustrated in FIGS. 1A and 1B is a liquid ejection apparatus (serial type liquid ejection apparatus) that performs image recording by ejecting the liquid onto a recording medium P using a liquid ejection head 1 that performs scanning in a direction intersecting a conveyance direction of the recording medium P. The present disclosure is applicable not only to a serial type liquid ejection apparatus but also to a page wide type liquid ejection apparatus that performs image recording by ejecting the liquid onto the recording medium conveyed in the conveyance direction using a line head (page wide type head) which is long in a page width direction of the recording medium. The liquid ejection head 1 according to the first embodiment can eject four types of inks of black (K), cyan (C), magenta (M), and yellow (Y), and can record a full-color image with the inks. The inks that can be ejected from the liquid ejection head 1 are not limited to the above four types of inks. The present disclosure is also applicable to a liquid ejection head capable of ejecting other types of inks, and the type and number of inks ejected from the liquid ejection head are not limited.

In the liquid ejection apparatus 50, the liquid ejection head 1 is mounted on a carriage 60. The carriage 60 moves back and forth along a guide shaft 51 in a main scanning direction (X direction). The recording medium P is conveyed in a sub-scanning direction (Y direction) intersecting the main scanning direction by conveyance rollers 55, 56, 57, and 58 that are conveyance members. In the first embodiment, the main scanning direction and the sub-scanning direction are orthogonal to each other. In each of the figures referred to below, a Z direction indicates a vertical direction and intersects an X-Y plane defined by the X direction and the Y direction. In the first embodiment, the Z direction is orthogonal to the X-Y plane.

FIG. 1A illustrates a configuration in which a main ink tank 2 as a liquid storage is provided outside the liquid ejection head 1. The ink stored in the main ink tank 2 is supplied to a sub-ink tank 54 on the liquid ejection head 1 through an ink supply tube 59 and the like by a driving force of an external pump 40. On the other hand, FIG. 1B illustrates a configuration in which the main ink tank 2 is not provided outside the liquid ejection head 1 and the ink tank 54 is included in the liquid ejection head 1. In such a configuration, the liquid ejection head 1 is provided integrally with the ink tank 54, and can be detachably attached to the carriage 60. Alternatively, the liquid ejection head 1 may be provided integrally with the carriage 60, and only the ink tank 54 may be detachably attached. The external pump 40 that supplies the ink to the ink tank 54 is a supply unit for supplying the ink to the liquid ejection head 1. The first embodiment will be described by taking the configuration of FIG. 1A as an example.

The liquid ejection head 1 includes an individual ejection unit described below. The individual ejection unit is a recording element unit in which an ejection nozzle for ejecting the liquid and an individual flow passage communicating with the ejection nozzle are formed, and a specific configuration thereof is described below. A pressure chamber is formed at a position corresponding to the ejection nozzle in the individual flow passage, and a first energy generation element (ejection energy generation element) that generates energy for ejecting the liquid from the ejection nozzle is provided in the pressure chamber. A second energy generation element (flow energy generation element) that generates energy for causing the liquid to flow is provided at a position different from the first energy generation element in the individual flow passage. The liquid ejection head 1 includes a plurality of individual ejection units, and has a supply flow passage for supplying the liquid to the individual flow passage in each individual ejection unit.

The ejection of the liquid may become unstable due to evaporation of volatile components such as moisture in the liquid from the ejection nozzle of the liquid ejection head 1 and the resulting solid component concentration near the ejection nozzle. Therefore, various measures are taken to prevent the instability. For example, the liquid ejection apparatus 50 can be provided with a cap member capable of covering an ejection nozzle surface on which the ejection nozzle of the liquid ejection head 1 is formed at a position deviating in the X direction from a conveyance passage of the recording medium P. The cap member is used to prevent the ejection nozzle from being dried and to protect the ejection nozzle by covering the ejection nozzle surface of the liquid ejection head 1 when a recording operation is not being performed, for example.

An ink suction mechanism can be provided. With such an ink suction mechanism provided, the cap member is used in an operation of suctioning the ink from the ejection nozzle, for example. By performing such an ink suctioning operation, it is possible to refresh the ink near the ejection nozzle and to maintain image quality of images achieved.

It is also possible to discard the concentrated ink by performing what is called preliminary ejection (pre-ejection) while the recording operation is not being performed. Such preliminary ejection may also be performed during the recording operation by ejecting an unnoticeable amount of ink at a position on the recording medium that is unnoticeable in terms of the image quality (paper sheet preliminary ejection/in-page preliminary ejection). Although such methods greatly contribute to improvement in image quality, an amount of ink is wasted, because some of the ink is discarded to refresh the ejection nozzle.

In relation to such a demand, by providing the second energy generation element (flow energy generation element) in the individual flow passage and circulating the ink through the flow passage, it is possible to suppress drying of the ejection nozzle and concentration of the ink near the ejection nozzle, while reducing the amount of waste ink. The number of times that preliminary ejection or suction recovery is performed can be reduced. Throughput and yield can be improved by reducing the number of times preliminary ejection or the like is performed.

The second energy generation element does not have to necessarily be provided in all the individual ejection units of the liquid ejection head. In a case where the second energy generation element is provided in some of the individual ejection units, the above-described effect can be achieved more effectively than in a case where no second energy generation element is provided.

The liquid ejection head 1 may have a configuration in which all portions corresponding to four types of inks include the second energy generation elements, or a configuration in which only a portion corresponding to one type of ink includes the second energy generation element. The liquid ejection head 1 may have a configuration in which only at least one type of ink is circulated instead of a configuration in which all the four types of inks are circulated.

### <Liquid Ejection Head>

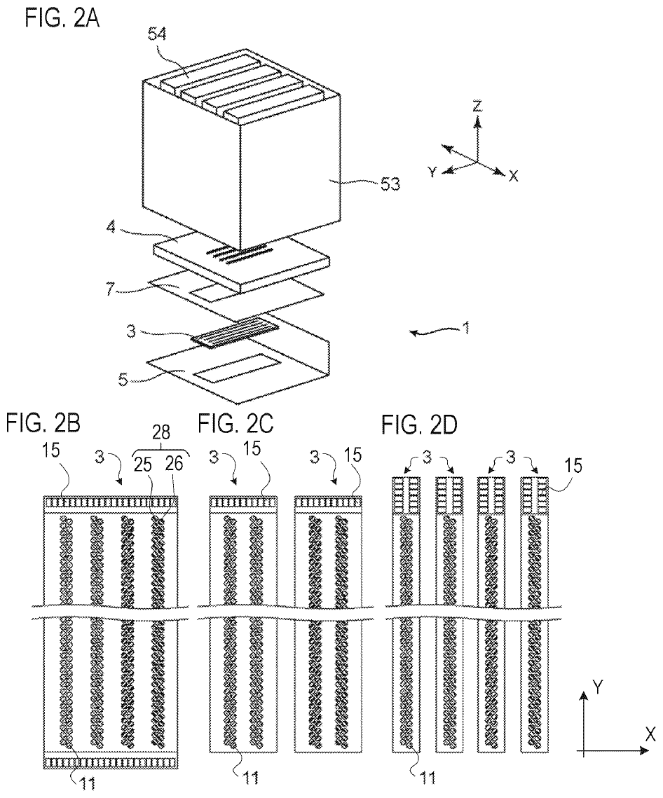

A configuration of the liquid ejection head 1 according to the first embodiment will be described. FIGS. 2A to 2D are views illustrating a configuration of the liquid ejection head 1 according to the first embodiment. FIG. 2A is an exploded perspective view of the liquid ejection head 1.

The liquid ejection head 1 includes four sub-ink tanks 54 for temporarily storing the inks, and a liquid ejection chip 3 for ejecting the inks supplied from the sub-ink tanks 54 onto the recording medium P.

The liquid ejection head 1 further includes a first support member 4, a second support member 7, and an electric wiring member 5 (electric wiring tape). The liquid ejection chip 3 is connected to one surface of the first support member 4, and the ink tanks 54 are connected to the other surface. The first support member 4 has flow passages penetrating therethrough from the one surface to the other surface, and the first support member 4 passes the inks supplied from the sub-ink tanks 54 to the liquid ejection chip 3, while supporting the liquid ejection chip 3.

The second support member 7 is connected to the first support member 4 on the surface to which the liquid ejection chip 3 is connected. The second support member 7 has an opening through which the liquid ejection chip 3 can be inserted, and the second support member 7 is connected to the first support member 4 with the liquid ejection chip 3 positioned inside the opening. Further, the second support member 7 supports the electric wiring member 5.

The electric wiring member 5 is electrically connected to the liquid ejection chip 3 and sends ejection signals for ejecting the ink, received from a main body of the liquid ejection apparatus 50 or the like, to the liquid ejection chip 3.

The liquid ejection head 1 according to the first embodiment is fixed to and supported by the carriage 60 of the liquid ejection apparatus 50, via an alignment unit and electrical contacts provided on the carriage 60. The liquid ejection head 1 performs recording on the recording medium P by ejecting the ink while moving with the carriage 60 in the main scanning direction (X direction).

The ink supply tube 59 is provided on the external pump 40 connected to the main ink tank 2 serving as an ink supply source (see FIG. 1A). A liquid connector is provided at a distal end of the ink supply tube 59. When the liquid ejection head 1 is mounted on the liquid ejection apparatus 50, the liquid connector provided at the distal end of the ink supply tube 59 is liquid-tight connection provided to a liquid connector insertion port that is a liquid introduction port provided in a housing of the liquid ejection head 1. As a result, an ink supply passage is formed from the ink tank 2 to the liquid ejection head 1 via the external pump 40. In the first embodiment, four types of inks are used, and thus, four sets of the ink tank 2, the external pump 40, the ink supply tube 59, and the sub-ink tank 54 are provided in total, each corresponding to a respective type of ink. Four ink supply passages corresponding to the respective inks are independently formed.

As described above, the liquid ejection apparatus 50 is provided with an ink supply system for supplying the ink from the ink tank 2 provided outside the liquid ejection head 1. The liquid ejection apparatus 50 is not provided with an ink recovery system that recovers the ink from the liquid ejection head 1 into the ink tank 2. Therefore, the liquid ejection head 1 is provided with the liquid connector insertion port for connecting the ink supply tube 59 of the ink tank 2, but the liquid ejection head 1 is not provided with a connector insertion port for connecting a tube for recovering the ink from the liquid ejection head 1 into the ink tank 2. Note that the liquid connector insertion port is provided for each ink.

FIGS. 2B, 2C, and 2D are views illustrating a configuration example of the liquid ejection chip 3 included in the liquid ejection head 1. Each of the liquid ejection chips 3 is provided with an ejection nozzle 11 and a pad 15 used for electrical mounting. FIG. 2A illustrates a chip configuration of FIG. 2B.

The liquid ejection head 1 can eject the inks of four colors. The four colors are, for example, black, cyan, magenta, and yellow. An ejection nozzle array 28 is formed for the ink of each color in the liquid ejection chip 3. One ejection nozzle array 28 includes a first row 25 and a second row 26 each including a plurality of ejection nozzles 11 arranged at equal intervals in the Y direction (first direction), and the first row 25 and the second row 26 are arranged side by side in the X direction (second direction). Positions of the ejection nozzles 11 included in the first row 25 and the ejection nozzles 11 included in the second row 26 in the Y direction are shifted from each other. Although a configuration in which the ejection nozzle array 28 includes the plurality of ejection nozzles 11 arranged in two rows is exemplified, a configuration in which the ejection nozzle array 28 includes the plurality of ejection nozzles 11 arranged in one row may be adopted.

FIG. 2B illustrates a configuration in which the ejection nozzle arrays 28 for the inks of four colors are provided in one liquid ejection chip 3, and the inks of four colors can be ejected by one liquid ejection chip 3. Note that a configuration in which two ejection nozzle arrays 28 are provided only for black, and a total of five ejection nozzle arrays 28 are provided for four colors may be adopted.

FIG. 2C illustrates a configuration in which one liquid ejection chip 3 is provided with ejection nozzles for the inks of two colors, and the inks of four colors can be ejected by two liquid ejection chips 3. As a configuration in which two liquid ejection chips 3 are mounted, two liquid ejection chips 3 may be mounted on one liquid ejection head 1, or two liquid ejection heads 1 each on which one liquid ejection chip 3 is mounted may be prepared.

FIG. 2D illustrates a configuration in which one liquid ejection chip 3 is provided with the ejection nozzle for the ink of one color, and the inks of four colors can be ejected by four liquid ejection chips 3. As a configuration in which four liquid ejection chips 3 are mounted, four liquid ejection chips 3 may be mounted on one liquid ejection head 1, or four liquid ejection heads 1 each on which one liquid ejection chip 3 is mounted may be prepared.

In addition, in a case where the plurality of liquid ejection chips 3 are provided as illustrated in FIGS. 2C and 2D, not all the liquid ejection chips 3 need to have the same chip length. Various combinations of other colors for the chips are possible, and the same applies in a case where the total number of colors is larger than four.

### <Straight Ink Circulation Configuration>

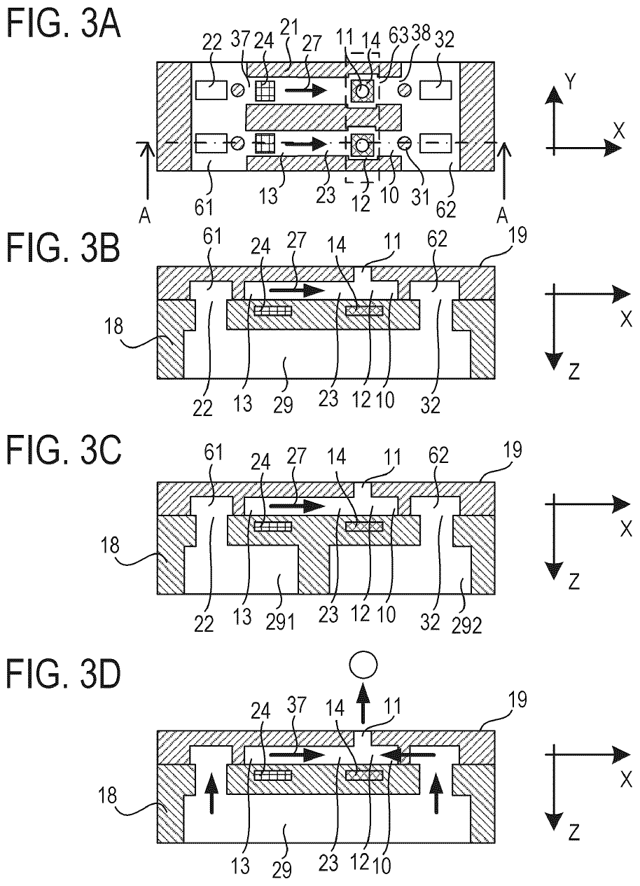

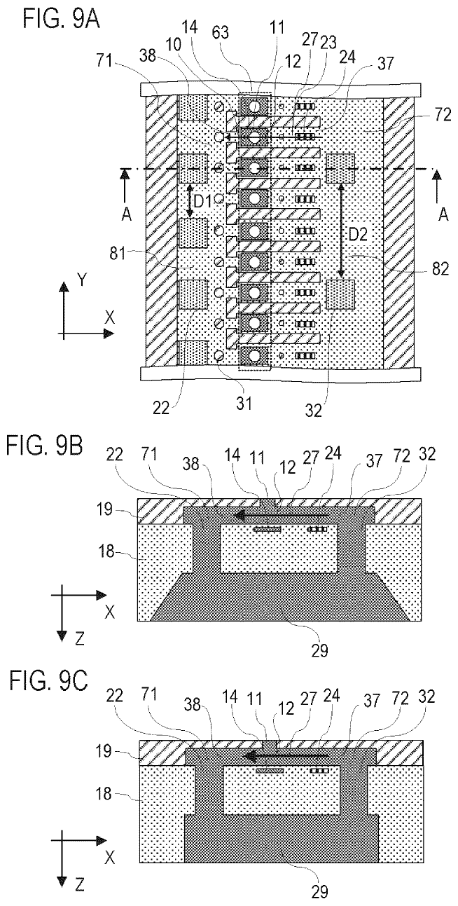

FIGS. 3A to 5D are views for describing a straight ink circulation configuration according to the first embodiment. FIGS. 3A to 5D are simple views for describing a circulation flow generation mechanism in the straight type ink circulation configuration and the effect thereof. Therefore, a configuration of the liquid ejection head 1 illustrated in FIGS. 3A to 5D is partially different from the configuration of the liquid ejection head 1 according to the first embodiment, as described herein with reference to FIGS. 9A to 11). However, an ink circulation generation mechanism and the effect thereof described with reference to FIGS. 3A to 5D are similar in the liquid ejection head 1 according to the first embodiment. The following description of FIGS. 3A to 5D incorporate by reference contents applicable to the liquid ejection head 1 according to the first embodiment, unless otherwise specified.

FIG. 3A is a view illustrating a configuration in the vicinity of the ejection nozzle 11 of the liquid ejection head, viewed in the Z direction. FIG. 3B is a cross-sectional view taken along line A-A in FIG. 3A. FIG. 3C is a cross-sectional view taken along line A-A in FIG. 3A and is a cross-sectional view of the liquid ejection head 1 having a configuration different from that of FIG. 3B. FIG. 3D is a cross-sectional view taken along line A-A in FIG. 3A and is a view illustrating a flow of the ink when the ink is ejected from the ejection nozzle.

The liquid ejection head 1 includes a stacked substrate 18 and an orifice plate 19, and an ejection nozzle array 63 including the plurality of ejection nozzles 11 arranged in the first direction (Y direction) is formed in the orifice plate 19. An ink meniscus is spread on the ejection nozzles 11, and an ejection nozzle interface as an interface between the ink and the atmosphere is formed.

A plurality of individual flow passages 23 that are partitioned by a partition wall 21, respectively communicate with the plurality of ejection nozzles 11, and extend in the second direction (X direction) are formed between the substrate 18 and the orifice plate 19. The individual flow passages 23 linearly extend in the second direction (X direction) intersecting the first direction (Y direction) in which the plurality of ejection nozzles 11 are arranged in the ejection nozzle array 63. In the example of FIGS. 3A to 3D, the second direction is a direction orthogonal to the first direction.

In addition, a first flow passage 61 with which one of each end of the plurality of individual flow passages 23 communicates and a second flow passage 62 with which the each other end of the plurality of individual flow passages 23 communicates are formed. The first flow passage 61 and the second flow passage 62 each extend in the Y direction and are positioned on opposite sides of the ejection nozzle array 63 in the X direction.

In the individual flow passage 23, a pressure chamber 12 is formed at a position corresponding to the ejection nozzle 11. The pressure chamber 12 communicates with the first flow passage 61 via a connection flow passage 13 and communicates with the second flow passage 62 via a connection flow passage 10. That is, the individual flow passage 23 includes the pressure chamber 12, the connection flow passage 10, and the connection flow passage 13.

In the substrate 18, a first energy generation element 14 (ejection energy generation element) that generates energy for ejecting the ink in the pressure chamber 12 is provided at a position corresponding to the ejection nozzle 11. Here, an electrothermal conversion element is used as the first energy generation element 14. By driving the first energy generation element 14 to generate heat and foam the ink in the pressure chamber 12, the ink can be ejected from the ejection nozzle 11 by energy resulting from the foaming. The first energy generation element 14 is not limited to the electrothermal conversion element, and a piezoelectric element or the like can be used.

The substrate 18 is provided with a second energy generation element 24 (flow energy generation element) that generates energy for generating a circulation flow 27 (flow) indicated by an arrow for the ink in the individual flow passage 23. Here, an electrothermal conversion element is used as the second energy generation element 24. The second energy generation element 24 is provided at a position different from that of the first energy generation element 14 in the X direction.

In the first flow passage 61, a plurality of first openings 22 through which the ink flows into or flows out from a common flow passage 29 are arranged in the Y direction. In the second flow passage 62, a plurality of second openings 32 through which the ink flows into or flows out from the common flow passage 29 are arranged in the Y direction. Each of the first opening 22 and the second opening 32 penetrates through the substrate 18 in a stacking Z direction.

The first energy generation element 14, the ejection nozzle 11, and the pressure chamber 12 are positioned closer to the second opening 32 than to the first opening 22. The second energy generation element 24 is positioned closer to the first opening 22 than to the second opening 32. The individual flow passage 23 communicates with the first opening 22 on one end side (−X direction side) in the X direction, and communicates with the second opening 32 on the other end side (+X direction side).

The connection flow passage 13 is positioned closer to the second energy generation element 24 in the X direction than to the ejection nozzle array 63. Both end portions of the individual flow passage 23 in the X direction are positioned on opposite sides of the ejection nozzle array 63.

There are mainly two types of ink flows in the individual flow passages 23, the two types of ink flows including (1) a first ink flow for replenishment after ink ejection by driving of the first energy generation element 14, and (2) a second ink flow which is the circulation flow 27 generated by driving of the second energy generation element 24.

When the first energy generation element 14 is driven and the ink is ejected from the ejection nozzle 11, a flow 37 in which the ink flows into the pressure chamber 12 of the individual flow passage 23 from both the first opening 22 and the second opening 32 is generated as illustrated in FIG. 3D. As a result, the ink is supplied from the first opening 22 and the second opening 32 to the individual flow passage 23.

When the second energy generation element 24 is driven to form the circulation flow 27, the ink flows into the individual flow passage 23 from an inflow port 37 adjacent to the connection flow passage 13 (first opening 22), and the ink flows out from an outflow port 38 adjacent to the connection flow passage 10 (second opening 32). The ink flowing out from the second opening 32 returns to the first opening 22 through the common flow passage 29. As a result, the circulation flow 27 indicated by the arrow is generated in the individual flow passage 23.

In the configuration illustrated in FIG. 3B, the first opening 22 and the second opening 32 are connected to the common flow passage 29 in the chip of the liquid ejection head 1. In the configuration illustrated in FIG. 3C, the first opening 22 and the second opening 32 are connected to a flow passage 291 and a flow passage 292 that are independent in the chip of the liquid ejection head 1, and are connected to a common flow passage outside the chip of the liquid ejection head 1. The present disclosure is applicable to both of the configurations.

Filters for removing foreign substances in the ink can be provided in ink circulation flow passages inside and outside the liquid ejection head 1. In the example illustrated in FIGS. 3A to 3D, filters 31 are provided in the vicinity of an end portion of the individual flow passage 23 on one end side (adjacent to the second energy generation element 24) and in the vicinity of an end portion of the individual flow passage 23 on the other end side (adjacent to the first energy generation element 14) in the X direction. The filter may also be disposed between the first energy generation element 14 and the second energy generation element 24 in the individual flow passage 23. In this case, the filter does not have to be disposed in the vicinity of the end portion of the individual flow passage 23 on one end side (adjacent to the second energy generation element 24) in the X direction.

In the liquid ejection head 1, the first energy generation element 14 and the second energy generation element 24 are arranged side by side in the X direction in the individual flow passage 23 linearly extending in the X direction. The circulation flow 27 of the ink can be generated in the individual flow passage 23 by driving the second energy generation element 24. Both end portions of the individual flow passage 23 are positioned on opposite sides of the ejection nozzle array 63 in the X direction.

Therefore, the inflow port 37 (upstream end) and the outflow port 38 (downstream end) of the circulation flow 27 are respectively connected to the first flow passage 61 and the second flow passage 62 that are different from each other, and are separated from each other. Such an ink circulation configuration is referred to as a straight type.

### <Circulation Flow Generation Process>

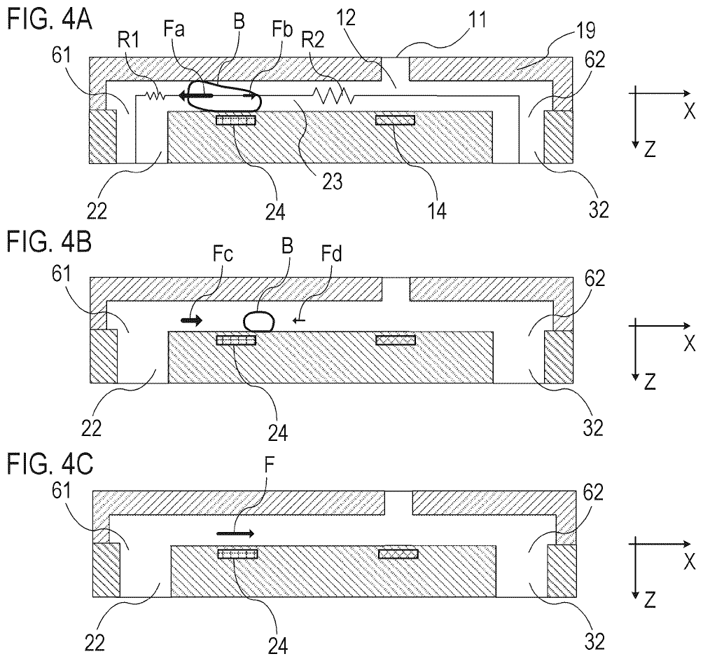

FIGS. 4A to 4C are views for describing a process of generating the ink circulation flow by driving the second energy generation element 24. FIGS. 4A, 4B, and 4C are cross-sectional views similar to FIG. 3B, and illustrate a process in which the ink is heated by the second energy generation element 24 and a bubble is generated, grows, contracts, and collapses due to film boiling of the ink.

FIG. 4A is a view illustrating a state in which a bubble B is generated by driving the second energy generation element 24 (circulation heater). The second energy generation element 24 is positioned closer to the first opening 22 than to the second opening 32. Therefore, a flow resistance R1 between the second energy generation element 24 and the first opening 22 is lower than a flow resistance R2 between the second energy generation element 24 and the second opening 32. FIG. 4A illustrates an equivalent circuit in which such flow resistances R1 and R2 are expressed as electric resistances. Due to a difference between the flow resistances R1 and R2, the bubble B generated due to the film boiling of the ink grows so as to be biased toward the first flow passage 61 with the lower flow resistance R1 as illustrated in FIG. 4A. Therefore, in the individual flow passage 23, a flow Fa of the ink toward the first flow passage 61 is greater than a flow Fb of the ink toward the second flow passage 62.

FIG. 4B is an explanatory view of a flow of the ink during a process in which the bubble B contracts. During the process in which the bubble B contracts, the ink flows so as to compensate for a volume of the contraction. In such a case, as illustrated in FIG. 4B, a flow Fc of the ink flowing from the first opening 22 with the lower flow resistance R1 is greater than a flow Fd of the ink flowing from the second opening 32 with the higher flow resistance R2. A position where the bubble B collapses is shifted toward the second opening 32 on the second energy generation element 24.

FIG. 4C is a view illustrating a flow of the ink after the bubble B collapses. A circulation flow F of the ink from the first opening 22 toward the second opening 32 is generated due to the relationship of Fc>Fd in FIG. 4B.

A magnitude of the circulation flow F is affected by a ratio between the flow resistances R1 and R2 and a size of the bubble B. For example, in a case where the electrothermal conversion element (heater) is used as the second energy generation element 24, the second energy generation element 24 is positioned closer to one of both end portions of the individual flow passage 23 than the first energy generation element 14. More specifically, a flow resistance ratio R1/R2 is set within a range of 0.05 to 0.40. By setting the flow resistance ratio R1/R2 in the range, the circulation flow F can be maximized.

The magnitude of the circulation flow F can be increased by increasing a magnitude of the flow Fa of the ink toward the first flow passage 61 illustrated in FIGS. 4A and 4B and increasing a magnitude of the flow Fc of the ink flowing from the first opening 22. Therefore, it is effective to reduce the flow resistance R1. The magnitude of the circulation flow F can be increased by decreasing a magnitude of the flow Fb of the ink toward the second flow passage 62 and decreasing a magnitude of the flow Fd of the ink flowing from the second opening 32. Therefore, it is effective to increase the flow resistance R2. As described above, the magnitude of the circulation flow F can be increased by decreasing the flow resistance R1 and increasing the flow resistance R2, that is, decreasing the flow resistance ratio R1/R2.

Here, the adjustment of the flow resistance ratio R1/R2 is not limited to a specific method and may be performed, for example, by changing a position of the second energy generation element 24 in the individual flow passage 23. That is, for example, the flow resistance R1 and the flow resistance R2 are changed by changing a flow passage distance between the second energy generation element 24 and the first opening 22 and a flow passage distance between the second energy generation element 24 and the second opening 32. Alternatively, a flow passage cross section on both sides with the second energy generation element 24 as a boundary may be changed, or both the flow passage distance and the flow passage cross section may be changed. As a method of changing the flow passage cross section, for example, the flow resistances R1 and R2 may be changed by disposing a structure that hinders a flow in the flow passage.

When a volume of the bubble B increases, a volume of the ink removed from the individual flow passage 23 by foaming increases, and thus the magnitude of the circulation flow F increases. As a method of increasing the volume of the bubble B, it is conceivable to increase a size of the second energy generation element 24, increase a width and a height of the connection flow passage 13 to decrease the flow resistance R1, decrease an ink viscosity, increase a temperature of the liquid ejection head 1, convert a drive pulse to a double pulse, or the like.

When a part of the circulation flow F of the ink enters the ejection nozzle 11, the concentrated ink in the ejection nozzle 11 is sent toward the second opening 32, and fresh ink flows into the ejection nozzle 11 from the first opening 22 through the connection flow passage 13. As a result, the concentrated ink can be suppressed from staying in the ejection nozzle 11, so that an influence of the concentrated ink can be reduced, and an initial ink ejection state can be maintained.

The circulation flow F is a transient flow generated along with a process in which the generated bubble B grows and contracts. Therefore, after the bubble B collapses, an inertial flow becomes weaker over time and is stopped after a certain period of time. By repeatedly driving the second energy generation element 24, the circulation flow F can be generated steadily for a certain period of time. A driving cycle of the second energy generation element 24 is not particularly limited as long as the concentrated ink in the ejection nozzle 11 can be discharged. However, since a time from the generation of the bubble B to the collapse of the bubble B is about 10 μs, the effect is reduced when the second energy generation element 24 is driven at a high driving frequency such as 100 kHz. Therefore, for example, to drive the second energy generation element 24 at a cycle of about 100 Hz to several tens of kHz may be set. When the driving frequency increases, the circulation flow F is maintained, and thus, the effectiveness of discharging the concentrated ink increases. On the other hand, when considering the rise in temperature of the ink due to the heat generated by the driving of the second energy generation element 24, appropriately control is set to drive the number of times the second energy generation element 24.

### <U-Shaped Ink Circulation Configuration>

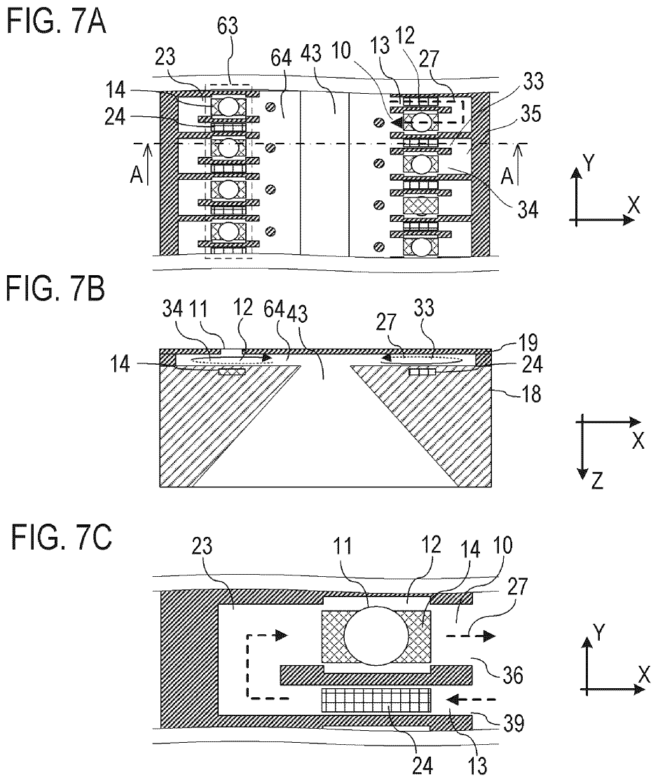

A U-shaped ink circulation configuration will be described as a comparative example for the straight ink circulation configuration. FIGS. 7A to 7C are views illustrating a liquid ejection head according to a comparative example. FIG. 7A is a view illustrating a configuration in the vicinity of an ejection nozzle 11 of the liquid ejection head according to the comparative example and is a view illustrating main components when the liquid ejection head is viewed in a Z direction. FIG. 7B is a cross-sectional view taken along line A-A in FIG. 7A. FIG. 7C is a view illustrating the vicinity of an individual flow passage in FIG. 7A.

The liquid ejection head according to the comparative example includes a stacked substrate 18 and an orifice plate 19. An ejection nozzle array 63 including a plurality of ejection nozzles 11 arranged in a first direction (Y direction) is formed in the orifice plate 19. First energy generation elements 14 and second energy generation elements 24 are alternately arranged in parallel with the ejection nozzle array 63.

A plurality of individual flow passages 23 that are partitioned by a partition wall 21, respectively communicate with the plurality of ejection nozzles 11, and are formed in a U shape are formed between the substrate 18 and the orifice plate 19. The individual flow passage 23 includes a first portion 33 and a second portion 34 extending in an X direction, and a third portion 35 extending in the Y direction and connecting one end sides of the first portion 33 and the second portion 34 in the X direction. The other end sides of the first portion 33 and the second portion 34 in the X direction communicate with a flow passage 64, and the flow passage 64 communicates with a common flow passage 43. Both end portions of the individual flow passage 23 are adjacent in the Y direction and communicate with the flow passage 64 on the same side (one side) in the X direction. The common flow passage 43 is provided so as to penetrate through the substrate 18.

The second energy generation element 24 is provided in the first portion 33, and a pressure chamber 12 and the first energy generation element 14 are provided in the second portion 34. The individual flow passage 23 is a flow passage formed so as to be bent in a U shape to connect the first energy generation element 14 and the second energy generation element 24 arranged side by side in the Y direction.

In the individual flow passage 23, the pressure chamber 12 is formed at a position corresponding to the ejection nozzle 11. The pressure chamber 12 communicates with the flow passage 64 via a connection flow passage 10 and communicates with the flow passage 64 via a connection flow passage 13. That is, the individual flow passage 23 includes the pressure chamber 12, the connection flow passage 10, and the connection flow passage 13. The connection flow passage 13 is formed in the first portion 33, the third portion 35, and a part of the second portion 34, and the connection flow passage 10 is formed in a part of the second portion 34. The first energy generation element 14 is positioned near a connection portion between the connection flow passage 10 and the flow passage 64, and the second energy generation element 24 is positioned near a connection portion between the connection flow passage 13 and the flow passage 64.

Flows of the ink in the individual flow passage 23 include (1) a first ink flow for replenishment after ink ejection by driving of the first energy generation element 14, and (2) a second ink flow which is a circulation flow 27 generated by driving of the second energy generation element 24.

In a case where the first energy generation element 14 is driven and the ink is ejected from the ejection nozzle 11, the ink flows into the pressure chamber 12 from both the connection flow passage 10 and the connection flow passage 13 in order to supply the ink accompanying the ejection from the common flow passage 43.

When the second energy generation element 24 is driven to form the circulation flow 27, the ink flows into the individual flow passage 23 from an inflow port 39 adjacent to the connection flow passage 13, and the ink flows out from an outflow port 36 adjacent to the connection flow passage 10. The circulation flow 27 indicated by an arrow and generated in the individual flow passage 23 causes the ink to flow into and flow out from the common flow passage 43. A configuration as illustrated in FIGS. 3A to 3D in which the flow passage 64 communicates with a common flow passage via a plurality of openings provided in the flow passage 64 and arranged in the Y direction may also be adopted. In this case, the plurality of openings communicate with the common flow passage in a chip similarly to FIG. 3B.

In the liquid ejection head according to the comparative example, the first energy generation element 14 and the second energy generation element 24 are arranged side by side in the Y direction along the ejection nozzle array 63 in the individual flow passage 23 formed in a U shape. The circulation flow 27 of the ink can be generated in the individual flow passage 23 by driving the second energy generation element 24. Both end portions of the individual flow passage 23 are positioned on the same side (one side) of the ejection nozzle array 63 in the X direction. Therefore, the inflow port 39 (upstream end) and the outflow port 36 (downstream end) of the circulation flow 27 are connected to the common flow passage 64. Such an ink circulation configuration is referred to as a U-shaped configuration.

### <Recirculation Concentration>

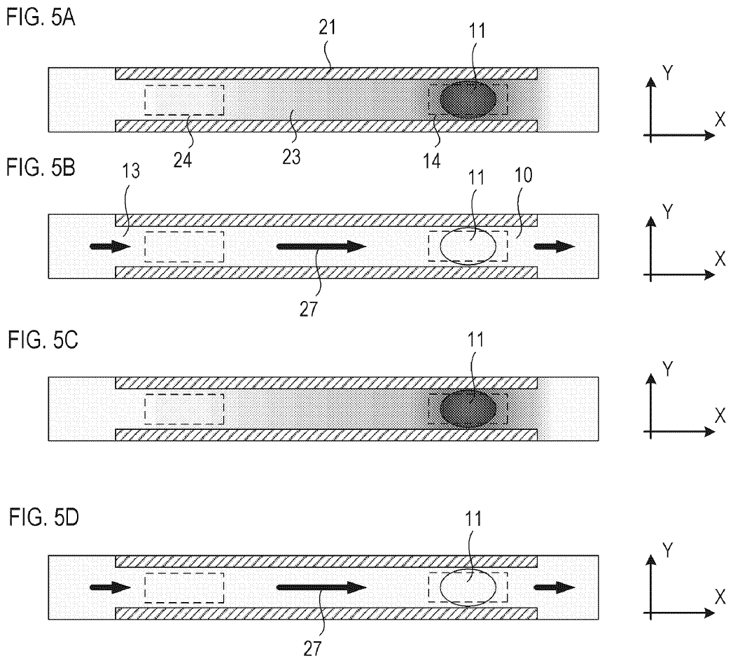

FIGS. 5A to 5D illustrate a state of the circulation flow and concentration of the ink in the straight ink circulation configuration. In FIGS. 5A to 5D, a concentration level of the ink is expressed using shades, and a dark portion indicates that the concentration level is high.

FIG. 5A illustrates a state in which the recording operation of the liquid ejection apparatus 50 is temporarily paused. When the recording operation is temporarily paused, the volatile components of the ink are evaporated from the ejection nozzle 11, and the concentration of the ink progresses in the vicinity of the ejection nozzle 11.

FIG. 5B illustrates a state immediately after the circulation flow 27 is generated by the second energy generation element 24. The concentration in the vicinity of the ejection nozzle 11 is eliminated by the circulation flow 27. The ink concentrated in the vicinity of the ejection nozzle 11 is discharged from the outflow port 38, fresh ink flows in from the inflow port 37, and the concentration is eliminated in the entire individual flow passage 23.

FIG. 5C illustrates a state in a case where the recording operation is temporarily paused again. As in the state illustrated in FIG. 5A, the concentration of the ink progresses in the vicinity of the ejection nozzle 11. FIG. 5D illustrates a state immediately after the circulation flow 27 is generated again by the second energy generation element 24. As in the state illustrated in FIG. 5B, the concentration in the vicinity of the ejection nozzle 11 is eliminated, and the concentration is also eliminated in the entire individual flow passage 23.

As described above, in the straight ink circulation configuration in which the inflow port 37 and the outflow port 38 of the individual flow passage 23 are separated from each other, the concentrated state is eliminated even when the temporary pause and the circulation operation are repeated.

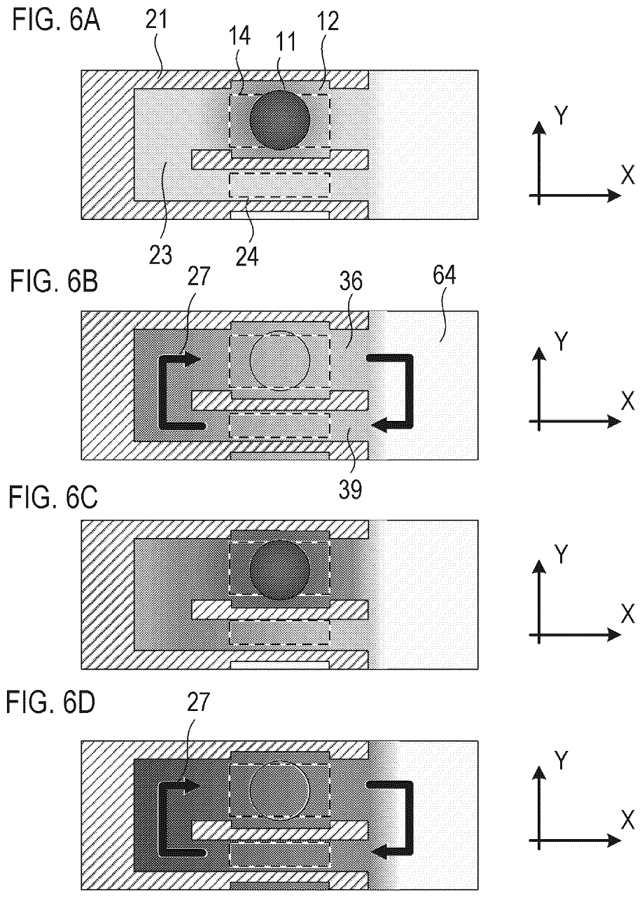

FIGS. 6A to 6D are views for describing a state of the circulation flow and concentration of the ink in the U-shaped ink circulation configuration according to the comparative example.

FIG. 6A illustrates a state in which a recording operation of the liquid ejection apparatus is temporarily paused. When the recording operation is temporarily paused, the ink is concentrated in the vicinity of the ejection nozzle 11.

FIG. 6B illustrates a state immediately after the circulation flow 27 is generated by the second energy generation element 24. In the U-shaped ink circulation configuration, the inflow port 39 and the outflow port 36 of the individual flow passage 23 are connected to and close to the common flow passage 64. Therefore, the ink concentrated in the vicinity of the ejection nozzle 11 is discharged from the outflow port 36 of the individual flow passage 23, but can flow into the individual flow passage 23 again from the inflow port 39. As a result, even if the circulation flow 27 is generated, the entire individual flow passage 23 is filled with the slightly concentrated ink instead of fresh ink. Such a phenomenon is referred to as recirculation concentration.

FIG. 6C illustrates a state in a case where the recording operation is temporarily paused again. The ink is further concentrated in the vicinity of the ejection nozzle 11 in the state illustrated in FIG. 6B.

FIG. 6D illustrates a state immediately after the circulation flow 27 is generated again by the second energy generation element 24. As described in FIG. 6B, the entire individual flow passage 23 is filled with the ink more concentrated than in FIG. 6B due to an influence of the recirculation concentration.

As described above, in the U-shaped ink circulation configuration in which the inflow port 39 and the outflow port 36 of the individual flow passage 23 are adjacent to each other, when the temporary pause and the circulation operation are repeated, the concentrated state is not eliminated, and the concentration gradually progresses in the entire individual flow passage 23. Further, even when the circulation operation has not yet been repeated, in a case where the ink is highly concentrated in the vicinity of the ejection nozzle 11 due to a long pause time or the like, the concentrated state is unlikely to be alleviated even with the first circulation operation. This is because the recirculation concentration is hardly effective in alleviating the concentrated state.

Therefore, there is a difference between the straight configuration in which an inlet and an outlet of the individual flow passage are separated from each other and the U-shaped configuration in which an inlet and an outlet of the individual flow passage are adjacent to each other in an aspect of concentration elimination when the circulation operation is performed after the temporary pause due to a difference in the influence of the discharged concentrated ink. In the straight configuration, the concentrated state in the entire individual flow passage is easily eliminated, and thus, ejection stability is hardly deteriorated by the concentrated ink. In the U-shaped configuration, on the other hand, the concentrated state in the entire individual flow passage is difficult to eliminate due to the recirculation concentration, and therefore, ejection is likely to become unstable depending on the concentration in the entire individual flow passage.

### <Ink>

As the ink circulation flow is generated in the individual flow passage 23 using the electrothermal conversion element (circulation heater) as the second energy generation element 24, the influence of the concentrated ink thickened by the evaporation of the volatile components at the ejection nozzle 11 can be reduced. Therefore, the ink ejection state can be favorably maintained, a change in ejection speed and the like can be reduced, so that the ejection can be stabilized.

Here, a coloring material type, a solid component content, and the like of the ink to be used may differ depending on an application of the liquid ejection head 1 or the liquid ejection apparatus 50. For example, in order to suppress curling (warping) and cockling (wavy wrinkling) of plain paper caused by water in the ink, it is conceivable to use ink with a reduced moisture amount. In the ink with a small moisture amount, since a concentration of a solid component such as an organic solvent other than water, a pigment, or a resin is high, a rapid viscosity increase is likely to occur along with evaporation of the moisture, which is likely to lead to deterioration of the ink ejection stability. In general, ink whose content of the solid component is 10 wt % (mass %) or more can be said to be ink whose content of the solid component is high.

In the liquid ejection head 1 according to the first embodiment, the circulation flow 27 can be generated in the individual flow passage 23 including the pressure chamber 12. Accordingly, even in a case where such ink containing the solid component of 10 wt % (mass %) or more is used, an increase in viscosity of the ink can be suppressed. Therefore, the present disclosure can be suitably applied to the liquid ejection head 1 and the liquid ejection apparatus 50 using ink containing a solid component of 10 wt % (mass %) or more. With the liquid ejection head 1 according to the first embodiment, the ejection stability can be favorably maintained regardless of a type of the ink.

In addition, an operating temperature of the liquid ejection head 1 may be increased to a constant temperature by disposing and controlling a heater on the entire chip. Since the viscosity of the ink varies depending on the temperature, the viscosity of the ink at the head operating temperature affects the ejection stability.

In the liquid ejection head 1 according to the first embodiment, a flow velocity of the circulation flow 27 that can be formed in the individual flow passage 23 by the second energy generation element 24 is several tens of mm/s to 1000 mm/s in terms of an instantaneous flow velocity. The flow velocity averaged over a time window on the order of several hundred us depends on the driving frequency of the second energy generation element 24. This is because the circulation flow 27 generated by the second energy generation element 24 is a transient flow that attenuates over time and is stopped after a certain period of time. An average flow velocity of the circulation flow 27 that can be formed in a case where the driving frequency of the second energy generation element 24 is about 10 to 20 kHz, which is substantially the same as a driving frequency (ejection frequency) of the first energy generation element 14, is several mm/s to 100 mm/s.

In a case where ink with a high pigment concentration is used, thickening of the ink progresses at the ejection nozzle 11 according to a non-ejection time (pause time), and the ejection speed changes, as a result of which the ejection stability is likely to be deteriorated. For example, ink having a concentration that results in a viscosity of at least 3 cP and not more than 6 cP at the head operating temperature can be said to be the ink with a high pigment concentration. In a case where such ink is used, ink circulation is performed during a short the pause time. Thus, concentration is eliminated by performing steady ink circulation or high-frequency transient ink circulation. In the liquid ejection head 1 according to the first embodiment, the transient ink circulation can be performed in the individual flow passage 23 by driving the second energy generation element 24. Therefore, in the liquid ejection head 1 according to the first embodiment, the concentration at the ejection nozzle 11 when highly concentrated ink is used can be eliminated by performing the circulation operation at a high frequency.

In a case where ink with a low pigment concentration is used, the ejection speed can change according to the non-ejection time (pause time), but the influence thereof is relatively small as compared with the ink with a high concentration. For example, ink having a concentration that results in a viscosity of 1 cP or more and less than 3 cP can be said to be the ink with a low pigment concentration. When the pause time increases, for example, the thickening of the ink progresses at the ejection nozzle 11 according to a non-printing driving time (stop time). When operation is restarted after stopping without performing printing for a certain period of time, the influence of the thickened ink can be reduced by performing recovery operations such as a suction operation, a wiping operation, and preliminary ejection in combination with the suction operation and the wiping operation, but such recovery operations result in waste ink.

In the liquid ejection head 1 according to the first embodiment, as the circulation flow 27 is formed in the individual flow passage 23 by driving the second energy generation element 24, the concentration at the ejection nozzle 11 can be eliminated, and the thickening of the ink can be suppressed. Therefore, depending on the stop time, it is also possible not to generate the waste ink by recovery processing including only the circulation operation. It is also possible to perform recovery processing to minimize the waste ink by combining the suction operation or the like for removing a bubble in the head but not for concentration elimination, while recovering by performing the circulation operation.

To reduce the influence of the concentrated ink regardless of the concentration of the ink, initial supply of fresh ink is provided to the vicinity of the ejection nozzle 11. In a case where the circulation heater is used as the second energy generation element 24, the smaller the influence of the recirculation concentration, the higher effectiveness of the ink circulation can be achieved. Compared with the U-shaped ink circulation configuration, the straight ink circulation configuration exhibits the higher effectiveness of maintaining ejection performance by ink circulation.

### <Driving Control>

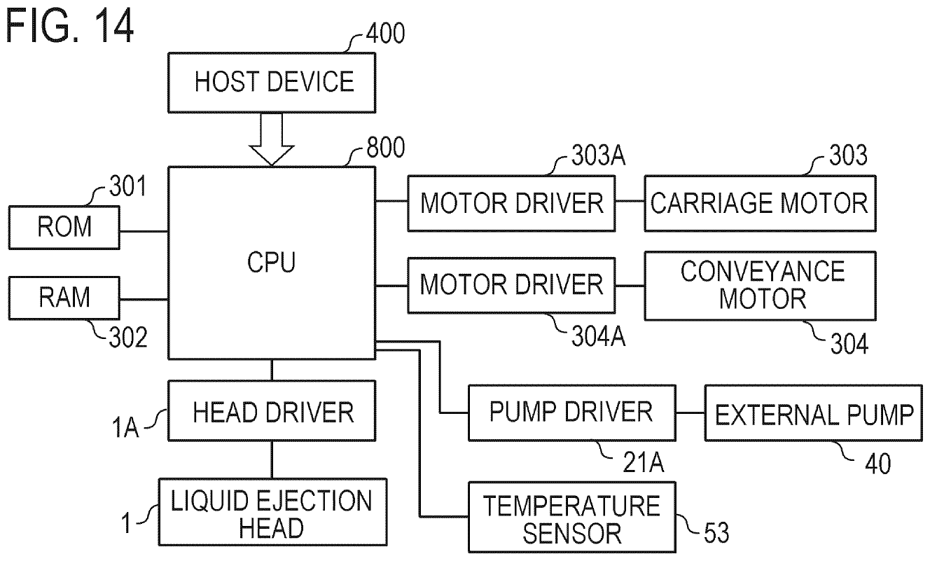

FIG. 14 is a block diagram illustrating a control configuration of the liquid ejection apparatus 50 according to the first embodiment. A CPU 800 is a control unit for controlling an operation of each portion of the liquid ejection apparatus 50 based on a program such as a processing procedure stored in a ROM 301. A RAM 302 is used as a working area or the like, when the CPU 800 executes processing. The CPU 800 receives image data from a host device 400 outside the liquid ejection apparatus 50 and controls a head driver 1A based on the image data to control the liquid ejection head 1. The CPU 800 controls the driving of the first energy generation element 14 and the second energy generation element 24 of the liquid ejection head 1 by the head driver 1A.

The CPU 800 also controls drivers of various types of actuators provided in the liquid ejection apparatus 50. For example, the CPU 800 controls a motor driver 303A of a carriage motor 303 for moving the carriage 60, a motor driver 304A of a conveyance motor 304 for conveying the recording medium P, a pump driver 21A of the external pump 40, and the like. Although FIGS. 2A to 2D illustrate configurations in which the image data is received from the host device 400, it is also possible to perform processing on the liquid ejection apparatus 50 without using any data from the host device 400.

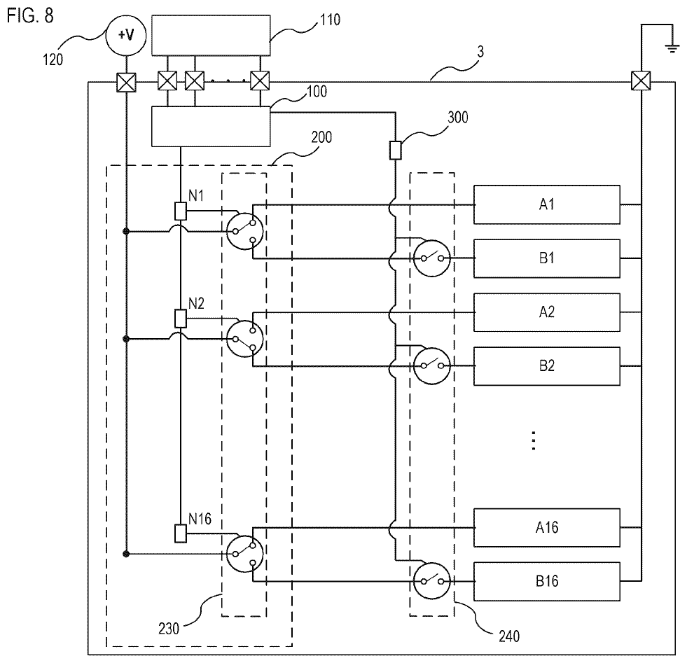

FIG. 8 is a diagram illustrating a control configuration of the liquid ejection head 1 according to the first embodiment. The substrate 18 of the liquid ejection chip 3 is provided with a controller 100, a selection drive circuit 200, an on/off drive circuit 240, the first energy generation element 14 (An) (n=1 to 16), and the second energy generation element 24 (Bn) (n=1 to 16). The liquid ejection chip 3 is connected to an external power supply 120 and an external circuit 110. The external circuit 110 includes the head driver 1A of FIG. 14. The CPU 800 that controls the head driver 1A is a control unit for controlling the driving of the first energy generation element 14 and the second energy generation element 24.

The selection drive circuit 200 includes an on-on drive circuit 230 that selects the first energy generation element 14 and the second energy generation element 24. In response to a control signal at each address Nn (n=1 to 16) received from the controller 100, the on-on drive circuit 230 turns on any one of the first energy generation element 14 and the second energy generation element 24 and drives the first energy generation element 14 or the second energy generation element 24. The controller 100 controls a drive pulse for driving the first energy generation element 14 or the second energy generation element 24 and a time interval at which the drive pulse is applied to each element.

The controller 100 controls the on/off drive circuit 240 by a driving enable/disable signal 300 of the second energy generation element 24. As a result, the driving of the second energy generation element 24 in a case where the second energy generation element 24 is selected in the on-on drive circuit 230 is controlled.

In this manner, the on-on drive circuit 230 and the on/off drive circuit 240 control the driving of the second energy generation element 24.

In a case where the driving enable/disable signal 300 is a signal that disables the driving of the second energy generation element 24, the second energy generation element 24 is not driven even if the second energy generation element 24 is selected in the on-on drive circuit 230. In this case, none of the first energy generation element 14 and the second energy generation element 24 is driven. On the other hand, in a case where the first energy generation element 14 is selected in the on-on drive circuit 230, the first energy generation element 14 is driven.

In a case where the driving enable/disable signal 300 is a signal that enables the driving of the second energy generation element 24, if the second energy generation element 24 is selected in the on-on drive circuit 230, the second energy generation element 24 is driven. If the first energy generation element 14 is selected, the first energy generation element 14 is driven.

Therefore, the second energy generation element 24 is controlled according to driving data of the first energy generation element 14 and the driving enable/disable signal 300. As a result, it is not necessary to provide the driving data for the second energy generation element 24, so that an amount of the driving data can be reduced to half.

In the example of FIG. 8, a configuration in which 16 sets (32 elements in total) of the first energy generation element 14 and the second energy generation element 24 are controlled as one group is illustrated, but the present disclosure is not limited thereto. For example, eight sets (16 elements) and 12 sets (24 elements) of the first energy generation element 14 and the second energy generation element 24 may be controlled as one group. In addition, even in a case where there are a plurality of second energy generation elements 24, it is possible to use the common driving enable/disable signal 300.

### <Characteristic of First Embodiment>

FIGS. 9A to 9C are views illustrating the liquid ejection head 1 according to the first embodiment. FIG. 9A is a view illustrating a configuration in the vicinity of the ejection nozzle 11 of the liquid ejection head 1 according to the first embodiment and is a view illustrating main components when the liquid ejection head 1 is viewed in the Z direction. FIG. 9B is a cross-sectional view taken along line A-A in FIG. 9A. FIG. 9C is a cross-sectional view taken along line A-A in FIG. 9A and is a cross-sectional view of the liquid ejection head 1 having a configuration different from that of FIG. 9B.

The liquid ejection head 1 according to the first embodiment includes an ejection nozzle array 63 including a plurality of ejection nozzles 11 arranged in the Y direction (first direction). The liquid ejection head 1 includes a plurality of individual flow passages 23 that communicate with the plurality of ejection nozzles 11 of the ejection nozzle array 63 and extend in the X direction. The plurality of individual flow passages 23 are arranged in parallel in the Y direction. A first energy generation element 14 that generates energy for ejecting the liquid from the ejection nozzle 11 is provided at a position corresponding to the ejection nozzle 11 in the plurality of individual flow passages 23. A second energy generation element 24 that generates energy for causing the liquid to flow is provided so as to be arranged at a position different from that of the first energy generation element 14 in the X direction in the plurality of individual flow passages 23.

A first flow passage 71 is provided on one side of the plurality of individual flow passages 23 in the X direction, the plurality of individual flow passages 23 being aligned in the Y direction. The first flow passage 71 is a flow passage extending in the Y direction along a row of the plurality of individual flow passages 23, and is a common flow passage communicating with one end of each of the plurality of individual flow passages 23. A second flow passage 72 is provided on the other side of the plurality of individual flow passages 23 in the X direction, the plurality of individual flow passages 23 being aligned in the Y direction. The second flow passage 72 is a flow passage extending in the Y direction along the row of the plurality of individual flow passages 23, and is a common flow passage communicating with the other end of each of the plurality of individual flow passages 23. The first flow passage 71 is provided with a plurality of first openings 22 which are arranged in the Y direction and through which the liquid flows into or flows out from the first flow passage 71. The second flow passage 72 is provided with a plurality of second openings 32 which are arranged in the Y direction and through which the liquid flows into or flows out from the second flow passage 72.

In each of the plurality of individual flow passages, the first energy generation element 14 is provided at a position closer to the first flow passage 71 than the second energy generation element 24, and the second energy generation element 24 is provided at a position closer to the second flow passage 72 than the first energy generation element 14. In the individual flow passage 23, the second energy generation element 24 is disposed such that a flow resistance R1 between the second energy generation element 24 and an end portion of the individual flow passage 23 that is adjacent to the second flow passage 72 is lower than a flow resistance R2 between the second energy generation element 24 and an end portion of the individual flow passage 23 that is adjacent to the first flow passage 71.

Therefore, as described in a reference example, in each of the plurality of individual flow passages 23, the liquid flows in a direction from the second flow passage 72 toward the first flow passage 71 by the energy generated by the second energy generation element 24. That is, a circulation flow 27 is a flow from the second energy generation element 24 toward the first energy generation element 14.

The plurality of first openings 22 provided in the first flow passage 71 are arranged at equal intervals with a predetermined pitch in the Y direction. Similarly, the plurality of second openings 32 provided in the second flow passage 72 are arranged at equal intervals with a predetermined pitch in the Y direction. In the present embodiment, the first opening 22 and the second opening 32 are rectangular openings having substantially the same shape, and the pitch of the plurality of first openings 22 and the pitch of the plurality of second openings 32 are different from each other. In the present embodiment, the pitch of the first openings 22 is smaller than the pitch of the second openings 32. That is, the number of first openings 22 per unit length in the Y direction is larger than the number of second openings 32 per unit length in the Y direction.

A size of a non-open part 81 in the Y direction between two adjacent first openings 22 is D1, and a size of a non-open part 82 in the Y direction between two adjacent second openings 32 is D2. The liquid ejection head 1 according to the modified example of the first embodiment is characterized in that D2 is greater than D1 (D2>D1). The non-open part 81 between two adjacent first openings 22 is a portion between the closest end portions of the adjacent first openings 22 in the Y direction and is a beam between a common flow passage 29 and the first flow passage 71 in the Z direction. The same applies to the non-open part 82. That is, the first embodiment can also be said to be characterized in that the beam between the first openings 22 is larger than a beam between the second openings 32. The first opening 22 is an opening closer to the ejection nozzle array 63 than the second opening 32 in the X direction. That is, a width (D2) of the beam between the openings far from the ejection nozzle array 63 can be said to be larger than a width (D1) of the beam between the openings close to the ejection nozzle array 63.

Further, the liquid ejection head 1 of the present embodiment is configured such that at least the number of second openings 32 per unit length in the Y direction is smaller than the number of first energy generation elements 14 and the number of second energy generation elements 24 per unit length in the Y direction. Specifically, in the present modified example, the first energy generation element 14 and the second energy generation element 24 are arranged at a pitch of 600 dpi. On the other hand, the first openings 22 are arranged at a pitch of 300 dpi, and the second openings 32 are arranged at a pitch of 150 dpi.

As an effect of the above configuration, deterioration of an ejection characteristic of an ejection heating element that is the first energy generation element 14 can be suppressed. Hereinafter, a specific description will be given.

It is necessary to supply the ink into the ejection nozzle 11 each time the ink is ejected by the first energy generation element 14. The ink is supplied to the ejection nozzle 11 such that the ink flowing from the first opening 22 through the individual flow passage 23 is supplied to the ejection nozzle 11. In a case where a distance from each individual flow passage 23 to the first opening 22 is different for each ink ejection portion including the ejection nozzle 11, the pressure chamber 12, and the first energy generation element 14, characteristics are different for each ink ejection portion. In particular, in the ink ejection portion far from the first opening 22, there is a possibility that a replenishment characteristic is deteriorated. Therefore, it is preferable to reduce the beam width D1 between the openings of the row of the first openings 22 close to the first energy generation element 14 that is the ejection heating element. As a method of reducing the beam width D1, it is common to increase a resolution of the row of the openings. On the other hand, the second energy generation element 24 only serves as a circulation heating element and only generates the circulation flow. Therefore, the beam width D2 between the openings in the row of the second openings 32 may be large. Therefore, a relationship between the beam width D1 between the openings in the row of the first openings 22 close to the first energy generation element 14 that is the ejection heating element and the beam width D2 between the openings in the row of the second openings 32 preferably satisfies D1<D2. As a result, deterioration of the replenishment characteristic of each ink ejection portion can be suppressed.

A shape of a back side of the substrate 18 varies depending on an etching method for the substrate 18. FIG. 9B illustrates a configuration in a case where the common flow passage 29 is formed in the substrate 18 by Si processing using anisotropic etching, and the first opening 22 and the second opening 32 are formed by dry processing. FIG. 9C illustrates a configuration in a case where the common flow passage 29 is formed in the substrate 18 by Si processing using dry etching, and the first opening 22 and the second opening 32 are further formed. The liquid ejection head 1 according to the modified example of the first embodiment can obtain the above effect when applied to a configuration including the substrate 18 of any shape.

In addition, the pitches of the first openings 22 and the second openings 32 with respect to the pitch of the first energy generation elements 14 are not limited to those in the above-described specific example. The pitch of the first openings 22 (the number per unit length in the Y direction) is preferably equal to or less than the pitch of the first energy generation elements 14 within a range in which the above-described effect of suppressing the deterioration of the replenishment characteristic of the ink ejection portion can be exhibited. Specifically, the pitch of the first openings 22 is preferably at least ¼ times and not more than 1 time the pitch of the first energy generation elements 14. The pitch of the second openings 32 is preferably at least ⅛ times and not more than ½ times the pitch of the first energy generation elements 14.

In addition, as the width of the beam between the first openings 22 and the width of the beam between the second openings 32 are increased, wirings for driving the first energy generation element 14 and the second energy generation element 24 can be easily routed, which is advantageous. That is, the wirings can be provided in a region (beam) between two adjacent first openings 22 and a region (beam) between two adjacent second openings 32.

### Second Embodiment

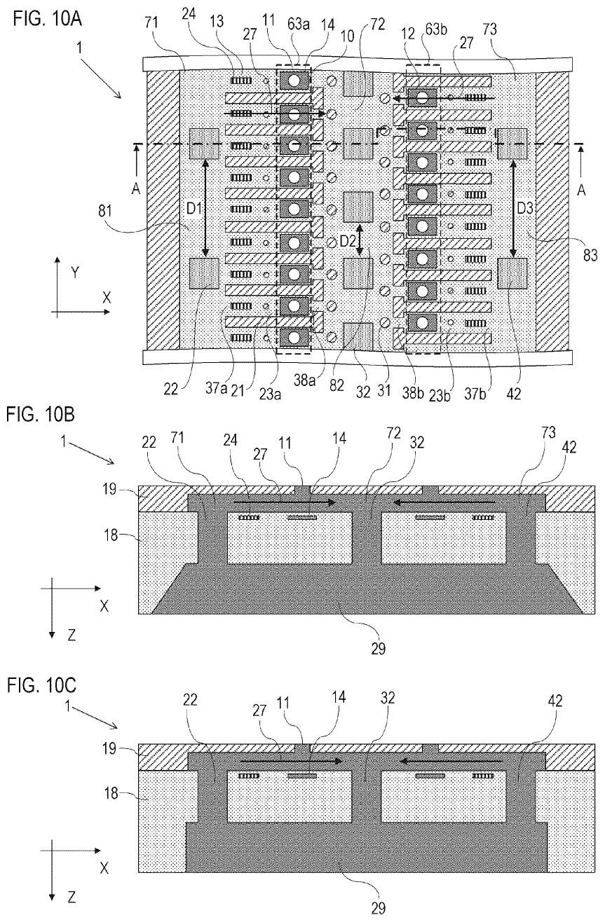

A liquid ejection head 1 according to a second embodiment will be described with reference to FIGS. 10A to 10C. The matters not specifically described herein for the second embodiment are the same as those in the first embodiment. FIGS. 10A to 10C are views illustrating the liquid ejection head 1 according to the second embodiment. FIG. 10A is a view illustrating a configuration in the vicinity of an ejection nozzle 11 of the liquid ejection head 1 according to the second embodiment and is a view illustrating main components when the liquid ejection head 1 is viewed in a Z direction. FIG. 10B is a cross-sectional view taken along line A-A in FIG. 10A. FIG. 10C is a cross-sectional view taken along line A-A in FIG. 10A and is a cross-sectional view of the liquid ejection head 1 having a configuration different from that of FIG. 10B.

The liquid ejection head 1 according to the second embodiment includes a first ejection nozzle array 63a and a second ejection nozzle array 63b each including a plurality of ejection nozzles 11 arranged in a first direction (Y direction). The second ejection nozzle array 63b is provided side by side with the first ejection nozzle array 63a in a second direction (X direction) intersecting the first direction (Y direction).

The liquid ejection head 1 includes a plurality of first individual flow passages 23a that respectively communicate with the plurality of ejection nozzles 11 of the first ejection nozzle array 63a and extend in the X direction, and a plurality of second individual flow passages 23b that respectively communicate with the plurality of ejection nozzles 11 of the second ejection nozzle array 63b and extend in the X direction.

A first energy generation element 14 that generates energy for ejecting a liquid from the ejection nozzle 11 is provided at a position corresponding to the ejection nozzle 11 in the plurality of first individual flow passages 23a and the plurality of second individual flow passages 23b. A second energy generation element 24 that generates energy for causing the liquid to flow is provided side by side with the first energy generation element 14 in the X direction in the plurality of first individual flow passages 23a and the plurality of second individual flow passages 23b.

A first flow passage 71 with which one ends 37a of the plurality of first individual flow passages 23a communicate is provided on a side of the first ejection nozzle array 63a that is opposite to the second ejection nozzle array 63b in the X direction. A second flow passage 72 with which the other ends 38a of the plurality of first individual flow passages 23a and one ends 38b of the plurality of second individual flow passages 23b communicate is provided between the first ejection nozzle array 63a and the second ejection nozzle array 63b in the X direction. A third flow passage 73 with which the other ends 37b of the plurality of second individual flow passages 23b communicate is provided on a side of the second ejection nozzle array 63b that is opposite to the first ejection nozzle array 63a in the X direction.

The first flow passage 71 is provided with a plurality of first openings 22 which are arranged in the Y direction and through which the liquid flows into or flows out from the first flow passage 71. The second flow passage 72 is provided with a plurality of second openings 32 which are arranged in the Y direction and through which the liquid flows into or flows out from the second flow passage 72. The third flow passage 73 is provided with a plurality of third openings 42 which are arranged in the Y direction and through which the liquid flows into or flows out from the third flow passage 73.

The first energy generation element 14 provided in the first individual flow passage 23a and the first energy generation element 14 provided in the second individual flow passage 23b are both positioned close to the second opening 32. The second energy generation element 24 provided in the first individual flow passage 23a is positioned close to the first opening 22, and the second energy generation element 24 provided in the second individual flow passage 23b is positioned close to the third opening 42.

In each of the plurality of first individual flow passages 23a, the second energy generation element 24 is provided at a position closer to the first flow passage 71 than the first energy generation element 14 in the X direction. Therefore, a flow resistance R1 between the second energy generation element 24 and an end portion of the first individual flow passage 23a that is adjacent to the first flow passage 71 is lower than a flow resistance R2 between the second energy generation element 24 and an end portion of the first individual flow passage 23a that is adjacent to the second flow passage 72.

In each of the plurality of second individual flow passages 23b, the second energy generation element 24 is provided at a position closer to the third flow passage 73 than the first energy generation element 14 in the X direction. Therefore, a flow resistance R1 between the second energy generation element 24 and an end portion of the second individual flow passage 23b that is adjacent to the third flow passage 73 is lower than a flow resistance R2 between the second energy generation element 24 and an end portion of the first individual flow passage 23a that is adjacent to the second flow passage 72.

Therefore, as described in the reference example, in each of the plurality of first individual flow passages 23a, the liquid flows in a direction from the first flow passage 71 toward the second flow passage 72 by the energy generated by the second energy generation element 24. In each of the plurality of second individual flow passages 23b, the liquid flows in a direction from the third flow passage 73 toward the second flow passage 72 by the energy generated by the second energy generation element 24. That is, the circulation flow 27 is a flow from the second energy generation element 24 toward the first energy generation element 14. As a result, a flow that flows in from the first opening 22 and the third opening 42 and flows out to the second opening 32 is generated.

D1 represents a size of a non-open part 81 between two adjacent first openings 22 in the Y direction, D2 represents a size of a non-open part 82 between two adjacent second openings 32 in the Y direction, and D3 represents a size of a non-open part 83 between two adjacent third openings 42 in the Y direction. The liquid ejection head 1 according to the second embodiment is characterized in that D1>D2 and D3>D2. The non-open part 81 between two adjacent first openings 22 is a portion between the closest end portions of the adjacent first openings 22 in the Y direction, and is a beam between a common flow passage 29 and the first flow passage 71 in the Z direction.

The same applies to the non-open parts 82 and 83. That is, the second embodiment can also be said to be characterized in that a beam between the first openings 22 and a beam between the third openings 42 are larger than a beam between the second openings 32.

In the second embodiment, the first opening 22, the second opening 32, and the third opening 42 have substantially the same shape, and the numbers of first openings 22 and third openings 42 per unit length in the Y direction are equal to each other and are smaller than the number of second openings 32. For example, the second openings 32 are arranged at a pitch of 300 dpi, and the first openings 22 and the third openings 42 are arranged at a pitch of 150 dpi. In this case, D1=D3.

Actions and effects of the liquid ejection head 1 according to the second embodiment will be described. A substrate 18 is a member having a large thermal capacity. In addition, in the substrate 18, a portion close to an outer edge portion that is in contact with the outside exhibits greater heat dissipation from the substrate 18 to the outside as compared to a central portion. In the liquid ejection head 1 according to the second embodiment, the beam between the first openings 22 and the beam between the third openings 42 in the first flow passage 71 and the third flow passage 73 that are close to the outer edge portion are larger than the beam between the second openings 32 in the second flow passage in the central portion. Therefore, a thermal resistance to the portion close to the outer edge portion, which exhibits greater heat dissipation, in the substrate 18 having a large thermal capacity is lower than a thermal resistance to the central portion of the substrate 18. Therefore, heat generated by driving of the second energy generation element 24 can be efficiently dissipated to the portion close to the outer edge portion of the substrate 18. As a result, it is possible to suppress an excessive temperature rise of a liquid ejection chip 3 and the liquid ejection head 1 due to the heat generated by the driving of the second energy generation element 24, and it is possible to suppress temperature unevenness in the liquid ejection chip 3.

By driving the second energy generation element 24, a circulation flow 27 is generated, and ink concentration at the ejection nozzle 11 can be eliminated. In order to increase an action of the circulation flow 27, it is effective to increase the number of times the second energy generation element 24 is driven. However, when the second energy generation element 24 is driven, ink ejection does not occur unlike driving of the first energy generation element 14. Therefore, the heat dissipation effect achieved by the ejection of the ink is small, and the heat is likely to be accumulated in the liquid ejection chip 3, and thus, the temperature of the liquid ejection chip 3 is likely to increase. When the temperature in the liquid ejection chip 3 increases, an evaporation speed from the ejection nozzle 11 increases, as a result of which the ink concentration in the vicinity of the ejection nozzle 11 easily progresses.

In this regard, the liquid ejection head 1 according to the second embodiment can efficiently dissipate the heat generated by driving the second energy generation element 24 from the outer edge portion of the substrate 18 as described above, and thus, accumulation of the heat in the liquid ejection chip 3 can be suppressed. Therefore, even if the number of times the second energy generation element 24 is driven is increased, it is possible to suppress the progress of the ink concentration due to the accumulation of heat.

In addition, each of the plurality of second energy generation elements 24 arranged for each ejection nozzle 11 can individually control ON/OFF of driving according to, for example, a concentration level for each ejection nozzle 11. However, in a case where the driving of the second energy generation element 24 is individually controlled to be ON/OFF, a temperature distribution is generated in the liquid ejection chip 3 due to an influence of the heat generated by the driving of the second energy generation element 24, and there is a possibility that temperature unevenness increases.

In this regard, the liquid ejection head 1 according to the second embodiment can efficiently dissipate the heat generated by driving the second energy generation element 24 from the outer edge portion of the substrate 18 as described above, so that the temperature unevenness in the liquid ejection chip 3 can be suppressed.

In a multicolor chip, an excessive temperature rise and temperature unevenness due to the influence of the heat as described above tend to appear due to an increase in chip length achieved by recent productivity improvement and a decrease in inter-row distance achieved by cost reduction. By applying the liquid ejection head 1 according to the second embodiment to such a multicolor chip, it is possible to suppress an excessive temperature rise and temperature unevenness due to the influence of the heat, which is preferable.

A shape of a back side of the substrate 18 varies depending on an etching method for the substrate 18. FIG. 10B illustrates a configuration in a case where the common flow passage 29 is formed in the substrate 18 by Si processing using anisotropic etching, and the first opening 22, the second opening 32, and the third opening 42 are formed by dry processing. FIG. 10C illustrates a configuration in a case where the common flow passage 29 is formed in the substrate 18 by Si processing using dry etching, and the first opening 22, the second opening 32, and the third opening 42 are further formed. The liquid ejection head 1 according to the second embodiment can obtain the above effect when applied to a configuration including the substrate 18 of any shape.

In addition, as the size of the beam between the first openings 22 and the size of the beam between the third openings 42 are increased, wirings for driving the first energy generation element 14 and the second energy generation element 24 can be easily routed, which is advantageous. That is, the wirings can be provided in a region (beam) between two adjacent first openings 22 and a region (beam) between two adjacent third openings 42.

In the liquid ejection head 1 according to the second embodiment, positions of the first opening 22 and the third opening 42 in the Y direction may be the same position as illustrated in FIG. 10A or may be different positions. For example, the positions of the first opening 22 and the third opening 42 in the Y direction may be shifted according to positions of the ejection nozzles 11 in the first ejection nozzle array 63a and the second ejection nozzle array 63b in the Y direction. The same applies to embodiments other than the second embodiment.

### <Modified Example of Second Embodiment>

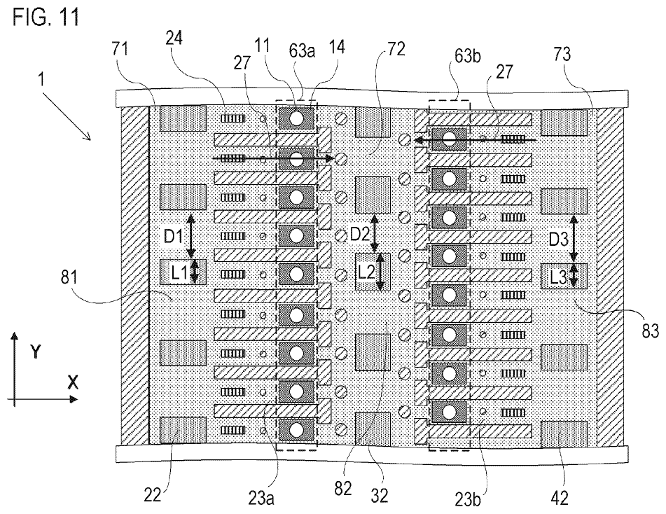

A modified example of the second embodiment will be described. FIG. 11 is a view illustrating a configuration in the vicinity of an ejection nozzle 11 of a liquid ejection head 1 according to the modified example, and is a view illustrating main components when the liquid ejection head 1 is viewed in the Z direction.

In the second embodiment, as illustrated in FIG. 10A, relationships D1>D2 and D3>D2 are satisfied by making the numbers of first openings 22 and third openings 42 per unit length smaller than the number of second openings 32.

On the other hand, in the modified example, as illustrated in FIG. 11, relationships D1>D2 and D3>D2 are satisfied by making shapes of the first opening 22 and the third opening 42 different from a shape of the second opening 32. In the example of FIG. 11, aspect ratios of the first opening 22 and the third opening 42 are made different from an aspect ratio of the second opening 32. Specifically, a size L1 of the rectangular first opening 22 in the Y direction and a size L3 of the third opening 42 in the Y direction are made smaller than a size L2 of the rectangular second opening 32 in the Y direction.

As a result, the relationships D1>D2 and D3>D2 are satisfied even if the numbers per unit length are the same among the first opening 22, the second opening 32, and the third opening 42. For example, the second openings 32 are arranged at a pitch of 300 dpi, and the first openings 22 and the third openings 42 are also arranged at a pitch of 300 dpi.

### Third Embodiment

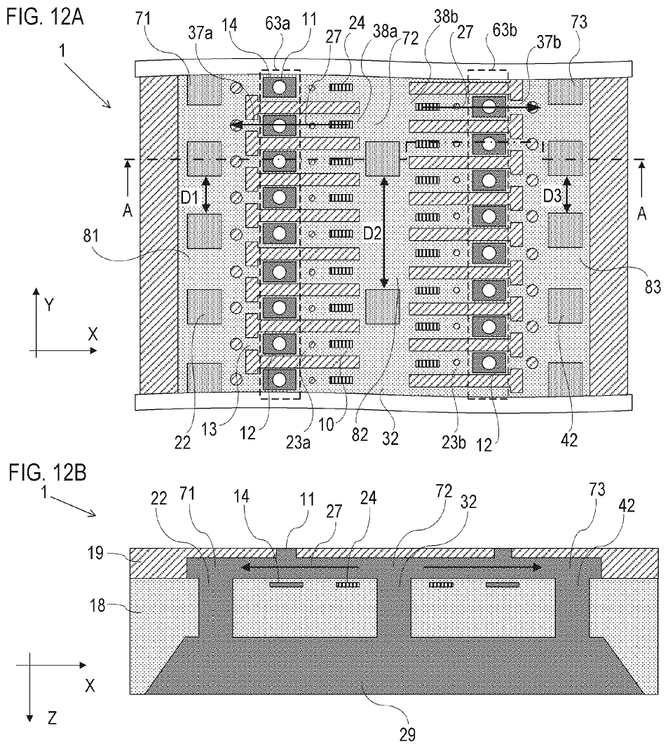

FIGS. 12A and 12B are views illustrating a liquid ejection head 1 according to a third embodiment. FIG. 12A is a view illustrating a configuration in the vicinity of an ejection nozzle 11 of the liquid ejection head 1 according to the third embodiment and is a view illustrating main components when the liquid ejection head 1 is viewed in a Z direction. FIG. 12B is a cross-sectional view taken along line A-A in FIG. 12A.

The third embodiment is different from the second embodiment in that a second energy generation element 24 provided in a first individual flow passage 23a and a second energy generation element 24 provided in a second individual flow passage 23b are both positioned close to a second opening 32. A first energy generation element 14 provided in the first individual flow passage 23a is positioned close to a first opening 22, and a first energy generation element 14 provided in the second individual flow passage 23b is positioned close to a third opening 42. In the second embodiment, D1>D2 and D3>D2, but in the third embodiment, D2>D1 and D2>D3. However, the second embodiment and the third embodiment are common in that a pitch of the openings (the second openings 32 in the second embodiment, and the first openings 22 and the third openings 42 in the third embodiment) close to the first energy generation element 14 is smaller than a pitch of the openings (the first openings 22 and the third openings 42 in the second embodiment, and the second openings 32 in the third embodiment) close to the second energy generation element 24.

In each of the plurality of first individual flow passages 23a, the second energy generation element 24 is provided at a position closer to a second flow passage 72 than the first energy generation element 14 in an X direction. Therefore, a flow resistance R1 between the second energy generation element 24 and an end portion of the first individual flow passage 23a that is adjacent to the second flow passage 72 is lower than a flow resistance R2 between the second energy generation element 24 and an end portion of the first individual flow passage 23a that is adjacent to the first flow passage 71.

In each of the plurality of second individual flow passages 23b, the second energy generation element 24 is provided at a position closer to the second flow passage 72 than the first energy generation element 14 in the X direction. Therefore, a flow resistance R1 between the second energy generation element 24 and an end portion of the second individual flow passage 23b that is adjacent to the second flow passage 72 is lower than a flow resistance R2 between the second energy generation element 24 and an end portion of the first individual flow passage 23a that is adjacent to a third flow passage 73.

Therefore, in each of the plurality of first individual flow passages 23a, the liquid flows in a direction from the second flow passage 72 toward the first flow passage 71 by energy generated by the second energy generation element 24. In each of the plurality of second individual flow passages 23b, the liquid flows in a direction from the second flow passage 72 toward the third flow passage 73 by the energy generated by the second energy generation element 24. That is, the circulation flow 27 is a flow from the second energy generation element 24 toward the first energy generation element 14. As a result, a flow that flows in from the second opening 32 and flows out to the first opening 22 and the third opening 42 is generated.

Actions and effects of the liquid ejection head 1 according to the third embodiment will be described. Since the circulation flow 27 flows toward an outer edge portion of a substrate 18, heat dissipation can be further promoted. As a result, it is possible to suppress an excessive temperature rise of a liquid ejection chip 3 and the liquid ejection head 1 due to the heat generated by the driving of the second energy generation element 24, and it is possible to suppress temperature unevenness in the liquid ejection chip 3.

Since ink concentrated in the vicinity of the ejection nozzle 11 is branched into the first flow passage 71 and the third flow passage 73 on both sides and discharged, an influence of the concentrated ink when re-flowing into the individual flow passage according to ejection or the like can be reduced. As a result, it is possible to further reduce the influence of the concentrated ink with the second energy generation element 24 while suppressing a variation in replenishment characteristic of an ink ejection portion.

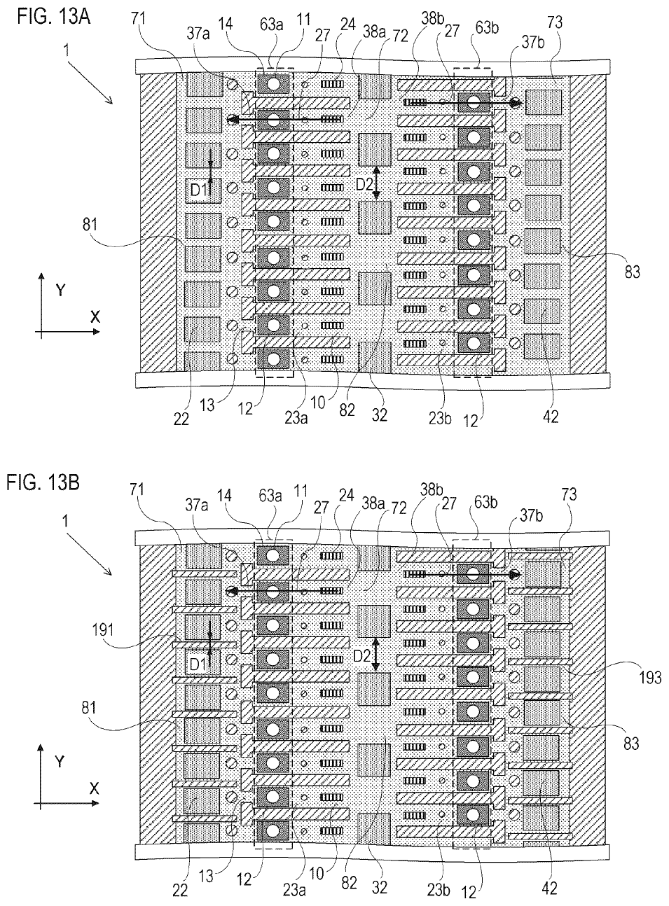

FIG. 13A illustrates a configuration in the vicinity of an ejection nozzle 11 of a liquid ejection head 1 according to a modified example of the third embodiment. FIG. 13B illustrates a configuration in the vicinity of an ejection nozzle 11 of a liquid ejection head 1 according to still another modified example of the third embodiment. All the figures are views illustrating main components when the liquid ejection head 1 is viewed in the Z direction.

In each modified example, second openings 32 are arranged at a pitch of 300 dpi, and both first openings 22 and third openings 42 are arranged at a pitch of 600 dpi. The first openings 22 and the third openings 42 are arranged with the same resolution (the number per unit length in the Y direction) as that of first energy generation elements 14. With such an arrangement configuration, a distance between the first energy generation element 14 and the first opening 22 and a distance between the first energy generation element 14 and the third opening 42 are substantially the same among the plurality of first energy generation elements 14. As a result, it is possible to further suppress deterioration of an ejection characteristic of the first energy generation element 14 that is an ejection heating element.

Further, in the modified example illustrated in FIG. 13B, a flow passage wall 191 partitioning between the plurality of first openings 22 and a flow passage wall 193 partitioning between the plurality of third openings 42 are provided. This makes it possible to suppress crosstalk of an ink circulation flow between the plurality of first openings 22 and crosstalk of an ink circulation flow between the plurality of third openings 42.

In each of the above embodiments, the respective configurations can be combined.

According to the present disclosure, it is possible to improve ejection characteristics and circulation characteristics for a liquid in a liquid ejection head including an energy generation element for ejecting the liquid and an energy generation element for causing the liquid to flow.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-160051, filed on Sep. 17, 2024, which is hereby incorporated by reference herein in its entirety.

1. A liquid ejection head comprising:
an ejection nozzle array that includes a plurality of ejection nozzles arranged in a first direction;
a plurality of individual flow passages configured to communicate with respective ejection nozzles of the plurality of ejection nozzles of the ejection nozzle array, extending in a second direction intersecting the first direction;
a first energy generation element configured to generate energy for ejecting liquid from at least one the ejection nozzle, wherein the first energy generation element is provided in at least one flow passage of the plurality of individual flow passages at a position corresponding to at least one ejection nozzle;
a second energy generation element configured to generate energy for causing the liquid to flow, wherein the second energy generation element is provided in at least one flow passage of the plurality of individual flow passages at a position different from the first energy generation element in the second direction;
a first flow passage in communication with one end of each of the plurality of individual flow passages;
a second flow passage in communication with an other end of each of the plurality of individual flow passages;
a plurality of first openings that are provided in the first flow passage, arranged in the first direction and configured to allow the liquid to flow at least one of into or out from the first flow passage; and
a plurality of second openings that are provided in the second flow passage, arranged in the first direction and configured to allow the liquid to flow at least one of into or out from the second flow passage,
wherein:
D2>D1,
with D1 representing a size of a non-open part in the first direction between two adjacent openings of the plurality of first openings, and
D2 representing a size of a non-open part in the first direction between two adjacent openings of the plurality of second openings.

2. The liquid ejection head according to claim 1, further comprising at least one other first energy generation element,
wherein a number of second openings per unit length in the first direction is less than a number of first energy generation elements per unit length in the first direction.

3. The liquid ejection head according to claim 2,
wherein the number of first openings per unit length in the first direction is at least ¼ times and not more than one times the number of first energy generation elements per unit length in the first direction.

4. The liquid ejection head according to claim 3,
wherein the number of second openings per unit length in the first direction is at least ⅛ times and not more than ½ times the number of first energy generation elements per unit length in the first direction.

5. The liquid ejection head according to claim 1,
wherein the first energy generation element is disposed at a position closer to the first opening than the second energy generation element in the second direction in an individual flow passage of the plurality of individual flow passages.

6. The liquid ejection head according to claim 1, further comprising:
electrical wiring provided in a region between two adjacent openings of the plurality of second openings.

7. A liquid ejection head comprising:
a first ejection nozzle array that includes a plurality of ejection nozzles arranged in a first direction;
a second ejection nozzle array that includes the plurality of ejection nozzles arranged in the first direction, and provided at a position different from the first ejection nozzle array in a second direction intersecting the first direction;
a plurality of first individual flow passages that communicate with respective ejection nozzles of the plurality of ejection nozzles of the first ejection nozzle array and extend in the second direction;
a plurality of second individual flow passages that communicate with respective ejection nozzles of the plurality of ejection nozzles of the second ejection nozzle array and extend in the second direction;
a plurality of first energy generation elements provided at positions corresponding to respective ejection nozzles in the plurality of first individual flow passages and the plurality of second individual flow passages, the first energy generation elements configured to generate energy for ejecting liquid from the ejection nozzle;
a plurality of second energy generation elements provided at positions different from the plurality of first energy generation elements in the second direction, provided in the plurality of first individual flow passages and the plurality of second individual flow passages, and configured to generate energy for causing the liquid to flow;
a first flow passage provided on a side of the first ejection nozzle array opposite to the second ejection nozzle array in the second direction, the first flow passage configured to communicate with a first end of each of the plurality of first individual flow passages;
a second flow passage provided between the first ejection nozzle array and the second ejection nozzle array in the second direction, the second flow passage configured to communicate with a second end of each of the plurality of first individual flow passages and with a first end of each of the plurality of second individual flow passages;
a third flow passage provided on a side of the second ejection nozzle array opposite to the first ejection nozzle array in the second direction, the third flow passage configured to communicate with a second end of each of the plurality of second individual flow passages;
a plurality of first openings provided in the first flow passage, arranged in the first direction, and configured to allow the liquid to flow one of into or out from the first flow passage;
a plurality of second openings provided in the second flow passage, arranged in the first direction, and configured to allow the liquid to flow one of into or out from the second flow passage; and
a plurality of third openings provided in the third flow passage, arranged in the first direction, and configured to allow the liquid to flow one of into or out from the third flow passage,
wherein:
D1>D2 and D3>D2,
with D1 representing a size of a non-open part in the first direction between the two adjacent first openings,
D2 representing a size of a non-open part in the first direction between two the adjacent second openings, and
D3 representing a size of a non-open part in the first direction between two the adjacent third openings, and
wherein a number of first openings and a number of third openings per unit length in the first direction is less than a number of first energy generation elements per unit length in the first direction.

8. The liquid ejection head according to claim 7,
wherein D1=D3.

9. The liquid ejection head according to claim 7,
wherein a number of second openings per unit length in the first direction is at least ¼ times and not more than one times a number of first energy generation elements per unit length in the first direction.

10. The liquid ejection head according to claim 7,
wherein a number of first openings and a number of third openings per unit length in the first direction are at least ⅛ times and not more than ½ times a number of first energy generation elements per unit length in the first direction.

11. The liquid ejection head according to claim 7,
wherein the plurality of first energy generation elements are disposed closer to respective second openings of the plurality of second openings than respective second energy generation elements in the second direction in each first individual flow passage and second individual flow passage.

12. A liquid ejection head comprising:
a first ejection nozzle array that includes a plurality of ejection nozzles arranged in a first direction;
a second ejection nozzle array that includes the plurality of ejection nozzles arranged in the first direction, and provided at a position different from the first ejection nozzle array in a second direction intersecting the first direction;
a plurality of first individual flow passages that communicate with respective ejection nozzles of the plurality of ejection nozzles of the first ejection nozzle array and extend in the second direction;
a plurality of second individual flow passages that communicate with respective ejection nozzles of the plurality of ejection nozzles of the second ejection nozzle array and extend in the second direction;
a plurality of first energy generation elements provided at a position corresponding to each of the ejection nozzles in the plurality of first individual flow passages and the plurality of second individual flow passages, and configured to generate energy for ejecting liquid from the ejection nozzle;
a plurality of second energy generation elements provided at a position different from the first energy generation element in the second direction, provided in the plurality of first individual flow passages and the plurality of second individual flow passages, and configured to generate energy for causing the liquid to flow;
a first flow passage provided on a side of the first ejection nozzle array opposite to the second ejection nozzle array in the second direction, the first flow passage configured to communicate with a first end of each of the plurality of first individual flow passages;
a second flow passage provided between the first ejection nozzle array and the second ejection nozzle array in the second direction, the second flow passage configured to communicate with a second end of each of the plurality of first individual flow passages and with a first end of each of the plurality of second individual flow passages;
a third flow passage provided on a side of the second ejection nozzle array opposite to the first ejection nozzle array in the second direction, the third flow passage configured to communicate with a second end of each of the plurality of second individual flow passages;
a plurality of first openings provided in the first flow passage, arranged in the first direction, and configured to allow the liquid to flow one of into or out from the first flow passage;
a plurality of second openings provided in the second flow passage, arranged in the first direction, and configured to allow the liquid to flow one of into or out from the second flow passage; and
a plurality of third openings provided in the third flow passage, arranged in the first direction, and configured to allow the liquid to flow one of into or out from the third flow passage,
wherein:
D2>D1 and D2>D3,
with D1 representing a size of a non-open part in the first direction between the two adjacent first openings,
D2 representing a size of a non-open part in the first direction between the two adjacent second openings, and
D3 representing a size of a non-open part in the first direction between the two adjacent third openings.

13. The liquid ejection head according to claim 12,
wherein a number of second openings per unit length in the first direction is less than a number of first energy generation elements per unit length in the first direction.

14. The liquid ejection head according to claim 12,
wherein D1=D3.

15. The liquid ejection head according to claim 12,
wherein a number of first openings and a number of third openings per unit length in the first direction are at least ¼ times and not more than one times a number of first energy generation elements per unit length in the first direction.

16. The liquid ejection head according to claim 12,
wherein a number of second openings per unit length in the first direction is at least ⅛ times and not more than ½ times a number of first energy generation elements per unit length in the first direction.

17. The liquid ejection head according to claim 12,
wherein the plurality of second energy generation elements are disposed closer to respective second openings of the plurality of second openings than respective first energy generation elements in the second direction in each first individual flow passage and second individual flow passage.

18. The liquid ejection head according to claim 12, further comprising:
electrical wirings provided in a region between the two adjacent first openings and a region between the two adjacent third openings.

19. The liquid ejection head according to claim 7,
wherein the plurality of the second energy generation elements is driven by a common control signal.

20. A liquid ejection apparatus comprising:
the liquid ejection head according to claim 1;
a supply unit configured to supply a liquid to the liquid ejection head; and
a control unit configured to control the first energy generation element and the second energy generation element.
